(19) United States
(12) Patent Application Publication
(10) Pub. No.: US 2023/0228636 A1
(43) Pub. Date: Jul. 20, 2023

(54) PASSIVE FIBER OPTIC CABINET AND SYSTEM FOR DETECTING STATE OF DOOR OF PASSIVE FIBER OPTIC CABINET

(71) Applicant: CommScope Technologies LLC, Hickory, NC (US)

(72) Inventor: Min DONG, Jiangsu (CN)

(73) Assignee: CommScope Technologies LLC, Hickory, NC (US)

(21) Appl. No.: 18/002,255

(22) PCT Filed: Jun. 23, 2021
(86) PCT No.: PCT/US2021/038710

§ 371 Date: Dec. 16, 2022

(30) Foreign Application Priority Data
Jun. 23, 2020 (CN) 202010579859.8
Jun. 23, 2020 (CN) 202021178491.6

(51) Int. Cl. G01L 1/24

(52) U.S. Cl. CPC G01L 1/246

(57) ABSTRACT

The present disclosure relates to a passive fiber optic cabinet and a system for detecting a state of a door of a passive fiber optic cabinet. A passive fiber optic cabinet is provided, comprising: a housing; a door coupled to the housing and configured to be switchable between an open state and a closed state; a switch sensor module including a detection fiber Bragg grating (FBG) sensor and a stress applying mechanism corresponding to the detection FBG sensor, the stress applying mechanism configured to apply a stress o the detection FBG sensor, one of the detection FBG sensor and the stress applying mechanism being positioned at the door, and the other of the detection FBG sensor and the stress applying mechanism being positioned at the housing.

### CROSS-REFERENCE TO RELATED APPLICATIONS

This application is being filed on Jun. 23, 2021 as a PCT International Patent Application and claims the benefit of Chinese Patent Application No. 202010579859.8, filed on Jun. 23, 2020, and claims the benefit of Chinese Patent Application No. 202021178491.6, filed on Jun. 23, 2020, the disclosures of which are incorporated herein by reference in their entireties.

### TECHNICAL FIELD

The present disclosure relates to the field of fiber optic communications, and more particularly, to a passive fiber optic cabinet and a system for detecting a state of a door of a passive fiber optic cabinet.

### BACKGROUND

With the rapid development of fiber optic communication technologies, the layout coverage and installation amount of passive fiber optic cabinets are increasingly large. The passive fiber optic cabinets are usually distributed dispersedly, most of which are installed outdoors and are generally unattended, and dummy resources bearing a large amount of important services are often deployed inside the passive fiber optic cabinets. The varying external environment, and the ease of contact by people/animals other than dedicated maintenance personnel, etc., pose a significant threat to the safety of the passive fiber optic cabinets. Fiber signal faults caused by illegal damage, theft, accident damage and the like of the passive fiber optic cabinets can cause a large amount of operation, maintenance and service losses of operators, and even bring huge economic losses to the whole society in severe cases. Therefore, it is very important to secure the passive fiber optic cabinets. The closure of the cabinet door plays a key role to the protection of equipment inside the passive fiber optic cabinets from being destroyed, waterproof, dustproof etc. However, for the detection of the state of the door of the passive fiber optic cabinet, at present, maintenance is generally performed by adopting modes such as manual inspection, passerby reporting and the like, and the maintenance personnel cannot remotely manage and monitor , so that it is difficult to timely grasp the state of the door of the passive fiber optic cabinet and make a response.

### SUMMARY

According to an aspect of the present disclosure, there is provided a passive fiber optic cabinet, comprising: a housing; a door coupled to the housing and configured to be switchable between an open state and a closed state; a switch sensor module including a detection fiber Bragg grating (FBG) sensor and a stress applying mechanism corresponding to the detection FBG sensor, the stress applying mechanism configured to apply a stress to the detection FBG sensor, one of the detection FBG sensor and the stress applying mechanism being positioned at the door, and the other of the detection FBG sensor and the stress applying mechanism being positioned at the housing.

In some embodiments, the stress applied to the detection FBG sensor by the stress applying mechanism is greater when the door is in the closed state than when the door is in the open state.

In some embodiments, the detection FBG sensor is disposed in an optical fiber and is configured to receive light including a detection wavelength associated with the detection FBG sensor, from an external light source via the optical fiber.

In some embodiments, the switch sensor module further includes a reference FBG sensor corresponding to the detection FBG sensor, the reference FBG sensor being positioned at the passive fiber optic cabinet at a position at which a temperature is substantially the same as a temperature at the position of the detection FBG sensor but no stress is applied to the reference FBG sensor by the stress applying mechanism.

In some embodiments, the reference FBG sensor is disposed in an optical fiber and is configured to receive light including a reference wavelength associated with the reference FBG sensor, from an external light source via the optical fiber.

In some embodiments, the reference FBG sensor and the detection FBG sensor are disposed in the same optical fiber, and wherein the reference wavelength is different from the detection wavelength.

In some embodiments, the passive fiber optic cabinet further comprises: a beam splitter configured to branch off at least one branch fiber from the optical fiber where the detection FBG sensor is disposed, wherein the reference FBG sensor is disposed in one of the at least one branch fiber, and wherein the reference wavelength is different from the detection wavelength.

In some embodiments, the detection wavelength depends on a refractive index of a core of the optical fiber where the detection FBG sensor is disposed and a grating period of the detection FBG sensor.

In some embodiments, the stress applying mechanism comprises a magnet.

In some embodiments, the detection wavelength is in a range from 1530 nm to 1565 nm.

In some embodiments, when the optical fiber where the detection FBG sensor is disposed is an optical fiber for fiber optic communication, the detection wavelength is outside an operating wavelength range for the fiber optic communication.

According to another aspect of the present disclosure, there is provided a system for detecting a state of a door of a passive fiber optic cabinet, comprising: a switch sensor module including a detection FBG sensor and a stress applying mechanism corresponding to the detection FBG sensor, the stress applying mechanism configured to apply a stress to the detection FBG sensor, one of the detection FBG sensor and the stress applying mechanism being positioned at the door of the passive fiber optic cabinet and the other of the detection FBG sensor and the stress applying mechanism being positioned at a housing of the passive fiber optic cabinet; a light source module configured to provide light including a detection wavelength associated with the detection FBG sensor to the detection FBG sensor; and an analysis module configured to receive reflected light reflected by the detection FBG sensor, determine a wavelength of the reflected light, and determine whether the door of the passive fiber optic cabinet is in an open state or a closed state based on the determined wavelength of the reflected light.

In some embodiments, the stress applied to the detection FBG sensor by the stress applying mechanism is greater when the door of the passive fiber optic cabinet is in the closed state than when the door of the passive fiber optic cabinet is in the open state.

In some embodiments, the detection FBG sensor is disposed in an optical fiber, and the light source module is configured to provide light to the detection FBG sensor via the optical fiber.

In some embodiments, the system comprises a plurality of switch sensor modules, wherein the detection FBG sensor of each of the switch sensor modules is disposed in a respective one of a plurality of optical fibers, and wherein the light source module is configured to provide light to the detection FBG sensor of one of the plurality of switch sensor modules via the respective optical fiber, respectively, through an optical switch.

In some embodiments, the switch sensor module includes a plurality of detection FBG sensors and a plurality of stress applying mechanisms corresponding to the plurality of detection FBG sensors, each of the detection FBG sensors and the corresponding stress applying mechanism being disposed at one of a plurality of passive fiber optic cabinets for detecting a state of a door of the one passive fiber optic cabinet, the plurality of detection FBG sensors being disposed in a same optical fiber, and detection wavelengths associated with the respective detection FBG sensors being different from each other.

In some embodiments, the switch sensor module further includes a reference FBG sensor corresponding to the detection FBG sensor, the reference FBG sensor being positioned at the passive fiber optic cabinet at a position at which a temperature is substantially the same as a temperature at the position of the detection FBG sensor but no stress is applied to the reference FBG sensor by the stress applying mechanism, the light source module further configured to provide light including a reference wavelength associated with the reference FBG sensor to the reference FBG sensor.

In some embodiments, the reference FBG sensor and the detection FBG sensor are disposed in the same optical fiber, and the reference wavelength is different from the detection wavelength.

In some embodiments, the system further comprises: a beam splitter configured to branch off at least one branch fiber from the optical fiber where the detection FBG sensor is disposed, wherein the reference FBG sensor is disposed in one of the at least one branch fiber, and wherein the reference wavelength is different from the detection wavelength.

In some embodiments, the detection wavelength depends on a refractive index of a core of the optical fiber where the detection FBG sensor is disposed and a grating period of the detection FBG sensor.

In some embodiments, the analysis module comprises a photoelectric conversion unit configured to convert the reflected light reflected by the detection FBG sensor into an electrical signal, and a processing unit configured to determine a wavelength of the reflected light based on the electrical signal from the photoelectric conversion unit.

In some embodiments, the processing unit is further configured to compare the determined wavelength of the reflected light with the detection wavelength to determine whether the door of the passive fiber optic cabinet is in an open state or a closed state.

In some embodiments, the processing unit is further configured to determine whether the door of the passive fiber optic cabinet is in an open state or a closed state based on a variation of the determined wavelength of the reflected light over time.

In some embodiments, the analysis module includes a dispersing unit configured to receive a plurality of reflected lights reflected by the plurality of detection FBG sensors and spatially disperse the plurality of reflected lights depending on wavelengths, a photoelectric conversion unit configured to receive the plurality of reflected lights spatially dispersed by the dispersing unit and output an electrical signal corresponding to each of the plurality of reflected lights, and a processing unit configured to determine a wavelength of each of the plurality of reflected lights based on the electrical signal from the photoelectric conversion unit.

In some embodiments, the dispersing unit comprises a dispersive optical element selected from a group comprising a dispersive mirror, a prism, or a grating.

In some embodiments, the photoelectric conversion unit comprises an array of photoelectric conversion elements, and the plurality of reflected lights reach different photoelectric conversion elements in the array after passing through the dispersing unit.

In some embodiments, the analysis module includes a wavelength selective unit configured to receive a plurality of reflected lights reflected by the plurality of detection FBG sensors and selectively output one of the plurality of reflected lights, a photoelectric conversion unit configured to receive the one reflected light output by the wavelength selective unit and output an electrical signal corresponding to the one reflected light, and a processing unit configured to determine a wavelength of the one reflected light based on the electrical signal from the photoelectric conversion unit.

In some embodiments, the wavelength selective unit comprises one of: a Fabry-Perot filter, a liquid crystal tunable filter, an acoustic-optic tunable filter, a monochromator.

In some embodiments, the light source module comprises at least one of: a broadband light source, a tunable laser source, and a combination of a plurality of narrow-band light sources.

In some embodiments, the stress applying mechanism comprises a magnet.

In some embodiments, the light source module outputs light in a wavelength range from 1530 nm to 1565 nm.

In some embodiments, when the optical fiber where the detection FBG sensor is disposed is an optical fiber for fiber optic communication, a wavelength range for the detection FBG sensor to detect the state of the door does not overlap with an operating wavelength range for the fiber optic communication.

In some embodiments, the light source module is configured to output light having a first intensity for monitoring the state of the door of the passive fiber optic cabinet, and the light source module is further configured to, when the analysis module determines that the door of the passive fiber optic cabinet is in the open state, output light having a second intensity higher than the first intensity for re-determining whether the door of the passive fiber optic cabinet is in the open state.

In some embodiments, the light source module and the analysis module are remotely positioned relative to the passive fiber optic cabinet.

In some embodiments, the system further comprises a trunk fiber, wherein the light source module is configured to provide light including the detection wavelength associated with the detection FBG sensor to the trunk fiber, and the switch sensor module further comprises a beam splitter corresponding to the detection FBG sensor, the beam splitter configured to branch off a branch fiber from the trunk fiber, wherein the detection FBG sensor is disposed in the branch fiber.

In some embodiments, the switch sensor module includes a plurality of detection FBG sensors, a plurality of stress applying mechanisms corresponding to the plurality of detection FBG sensors, and a plurality of beam splitters corresponding to the plurality of detection FBG sensors, each of the detection FBG sensors and the corresponding stress applying mechanism and corresponding beam splitter being disposed at one of a plurality of passive fiber optic cabinets for detecting a state of a door of the one passive fiber optic cabinet, each of the detection FBG sensors being disposed in a branch fiber branched off from the trunk fiber via the beam splitter corresponding to the detection FBG sensor.

In some embodiments, detection wavelengths associated with the respective detection FBG sensors of the plurality of detection FBG sensors are different from each other.

In some embodiments, the plurality of detection FBG sensors include at least a first detection FBG sensor and a second detection FBG sensor, the first and second detection FBG sensors configured such that a detection wavelength associated with the first detection FBG sensor is the same as a detection wavelength associated with the second detection FBG sensor, and a distance along the fiber from the first detection FBG sensor to the analysis module and a distance along the fiber from the second detection FBG sensor to the analysis module differ by at least a first threshold configured such that a time difference between when the reflected lights from the first and second detection FBG sensors are received by the analysis module is no less than a predetermined time threshold.

In some embodiments, the light source module is configured to provide a light pulse including detection wavelengths associated with the plurality of detection FBG sensors to the trunk fiber, the analysis module is further configured to determine a passive fiber optic cabinet of the plurality of passive fiber optic cabinets that corresponds to the reflected light based on the determined wavelength of the reflected light and the time at which the reflected light is received.

In some embodiments, an output wavelength range of the light source module is divided into a plurality of wavelength ranges to be assigned to the plurality of detection FBG sensors, a detection wavelength associated with each detection FBG sensor being within a wavelength range assigned to the detection FBG sensor, the analysis module is configured to determine, based on a wavelength range in which the determined wavelength of the reflected light is, a passive fiber optic cabinet of the plurality of passive fiber optic cabinets having a detection FBG sensor corresponding to the wavelength range.

In some embodiments, the system further comprises an alarm module configured to issue an alarm in response to the analysis module determining that there is a wavelength range, among the plurality of wavelength ranges, that none of wavelengths of the received reflected lights falls therein.

According to another aspect of the present disclosure, there is provided a system for detecting a state of a door of a passive fiber optic cabinet, comprising: a plurality of passive fiber optic cabinets, each being the passive fiber optic cabinet of any embodiment according to the aspect of the present disclosure; a light source module configured to provide light including detection wavelengths associated with the detection FBG sensors to the detection FBG sensors; and an analysis module configured to receive reflected lights reflected by the detection FBG sensors, determine wavelengths of the reflected lights, and determine whether the doors of the passive fiber optic cabinets are in an open state or a closed state based on the determined wavelengths of the reflected lights.

In some embodiments, the detection FBG sensors of the plurality of passive fiber optic cabinets are disposed in a same optical fiber, and the detection wavelengths associated with the respective detection FBG sensors are different from each other.

In some embodiments, the plurality of passive fiber optic cabinets comprises a first group of passive fiber optic cabinets and a second group of passive fiber optic cabinets, the detection FBG sensors of each of the first group of passive fiber optic cabinets are disposed in a first optical fiber, and the detection wavelengths associated with the respective detection FBG sensors of the first group of passive fiber optic cabinets are different from each other, the detection FBG sensors of each of the second group of passive fiber optic cabinets are disposed in a second optical fiber different from the first optical fiber, and the detection wavelengths associated with the respective detection FBG sensors of the second group of passive fiber optic cabinets are different from each other.

In some embodiments, the detection wavelengths associated with the respective detection FBG sensors of the first group of passive fiber optic cabinets and the detection wavelengths associated with the respective detection FBG sensors of the second group of passive fiber optic cabinets have at least one same detection wavelength.

In some embodiments, the light source module is configured to provide light to the respective detection FBG sensors of the first group of passive fiber optic cabinets and the respective detection FBG sensors of the second group of passive fiber optic cabinets via the first and second optical fibers, respectively, through an optical switch.

In some embodiments, the detection FBG sensors of the first group of passive fiber optic cabinets include at least a first detection FBG sensor, the detection FBG sensors of the second group of passive fiber optic cabinets include at least a second detection FBG sensor, the first and second detection FBG sensors configured such that a detection wavelength associated with the first detection FBG sensor is the same as a detection wavelength associated with the second detection FBG sensor, and a distance along the fiber from the first detection FBG sensor to the analysis module and a distance along the fiber from the second detection FBG sensor to the analysis module differ by at least a first threshold configured such that a time difference between when the reflected lights from the first and second detection FBG sensors are received by the analysis module is no less than a predetermined time threshold.

In some embodiments, the analysis module is configured to determine whether the doors of the passive fiber optic cabinets are in an open state or a closed state based on variations of the determined wavelengths of the reflected lights over time.

Other features and advantages of the present disclosure will become more apparent from the following detailed description of exemplary embodiments of the present disclosure with reference to the accompanying drawings.

### BRIEF DESCRIPTION OF THE ACCOMPANYING DRAWINGS

The foregoing and other features and advantages of the present disclosure will become apparent from the following description of the embodiments of the present disclosure in conjunction with the accompanying drawings. The accompanying drawings, which are incorporated herein and form a part of the specification, further serve to explain the principles of the present disclosure and to enable a person skilled in the art to make and use the present disclosure, wherein:

FIG. 1 is an exemplary schematic diagram illustrating a passive fiber optic cabinet with its door in an open state, according to some embodiments of the present disclosure;

FIG. 1A is a schematic diagram schematically illustrating an FBG sensor disposed in an optical fiber according to some embodiments of the present disclosure;

FIG. 1B schematically illustrates spectrum diagrams of light incident to, reflected by, and transmitted from the FBG sensor;

FIG. 2 is an exemplary schematic diagram illustrating a passive fiber optic cabinet with its door in an open state, according to some embodiments of the present disclosure;

FIG. 2A is a schematic diagram schematically illustrating two FBG sensors disposed in an optical fiber according to an embodiment of the present disclosure;

FIG. 2B schematically illustrates spectrum diagrams of light incident to, reflected by, and transmitted from the two FBG sensors;

FIGS. 3A and 3B are diagrams schematically illustrating an exemplary configuration in which a reference FBG sensor is provided in the passive fiber optic cabinet;

FIGS. 4A and 4B are exemplary schematic diagrams illustrating a system for detecting a state of a door of a passive fiber optic cabinet according to some embodiments of the present disclosure;

FIG. 5 is an exemplary schematic diagram illustrating a system for detecting a state of a door of a passive fiber optic cabinet according to some embodiments of the present disclosure;

FIGS. 6A and 6B are diagrams schematically illustrating an exemplary configuration in which a reference FBG sensor is provided in a switch sensor module;

FIG. 7 is an exemplary schematic diagram illustrating a system for detecting a state of a door of a passive fiber optic cabinet according to some embodiments of the present disclosure;

FIGS. 8A and 8B are diagrams schematically illustrating an exemplary configuration in which reference FBG sensors are provided when the switch sensor module includes a plurality of detection FBG sensors;

FIG. 9 is an exemplary block diagram schematically illustrating an analysis module of a system for detecting a state of a door of a passive fiber optic cabinet, according to some embodiments of the present disclosure;

FIG. 10 is a flowchart illustrating an exemplary method for detecting a state of a door of a passive fiber optic cabinet, according to some embodiments of the present disclosure;

FIG. 11 is a flowchart illustrating an exemplary method for detecting a state of a door of a passive fiber optic cabinet, according to some embodiments of the present disclosure;

FIG. 12A and FIG. 12B shows a variation of a wavelength reflected by the detection FBG sensor over time according to some embodiments of the present disclosure; and

FIG. 13 is an exemplary schematic diagram illustrating a system for detecting a state of a door of a passive fiber optic cabinet according to some embodiments of the present disclosure.

Note that in the embodiments described below, sometimes a same reference sign is used in common among different accompanying drawings to denote the same portions or portions having the same function, but a repetitive description thereof will be omitted. In some cases, similar items are denoted using similar reference signs and letters, and thus, once an item is defined in a drawing, it need not be discussed further in subsequent drawings.

For convenience of understanding, the positions, dimensions, ranges and the like of the respective structures shown in the drawings and the like sometimes do not indicate actual positions, dimensions, ranges and the like. Therefore, the present disclosure is not limited to the positions, dimensions, ranges and the like disclosed in the drawings and the like.

### DETAILED DESCRIPTION

Various exemplary embodiments of the present disclosure will be described in detail below with reference to the accompanying drawings. It should be noted that: the relative arrangement of parts and steps, numerical expressions and numerical values set forth in these embodiments do not limit the scope of the present disclosure unless specifically stated otherwise.

The following description of at least one exemplary embodiment is merely illustrative in nature and is in no way intended to limit the present disclosure, and its applications, or uses. That is, the structures and methods herein are illustrated by way of example to illustrate different embodiments of the structures and methods of the present disclosure. Those skilled in the art will understand, however, that they are merely illustrative of exemplary implementations of the present disclosure but not exhaustive. Furthermore, the drawings are not necessarily drawn to scale, and some features may be exaggerated to show details of particular components.

Additionally, techniques, methods, and apparatus known to one of ordinary skill in the relevant art may not be discussed in detail but are intended to be part of the specification where appropriate.

In all examples illustrated and discussed herein, any particular value should be construed as exemplary only and not as limiting. Thus, other examples of the exemplary embodiments may have different values.

Passive fiber optic cabinets are typically installed outdoors and often unattended, and when a cabinet door is opened unintentionally (e.g., a worker installing the passive fiber optic cabinet forgets to close the door or the door is not closed properly) or maliciously (e.g., someone intentionally opens the cabinet door for malicious operation), for example, the varying external environment and the ease of contact by people/animals other than dedicated maintenance personnel pose a significant threat to the safety of the passive fiber optic cabinets. Therefore, it is necessary to detect the state of the door of the passive fiber optic cabinet so as to protect the equipment inside the passive fiber optic cabinet from being damaged by the outside. Generally, the equipment for detecting the state of the door usually needs to be powered, so that a power supply needs to be additionally provided in the passive fiber optic cabinet to supply power to the equipment, which not only increases the manufacturing and maintenance cost, but also results in problems such as insufficient reliability and security of the equipment, and difficulty in large-scale expansion and application.

One aspect of the present disclosure provides a passive fiber optic cabinet, comprising: a housing; a door coupled to the housing and configured to be switchable between an open state and a closed state; a switch sensor module including a detection FBG sensor and a stress applying mechanism corresponding to the detection FBG sensor, the stress applying mechanism configured to apply a stress to the detection FBG sensor, one of the detection FBG sensor and the stress applying mechanism being positioned at the door, and the other of the detection FBG sensor and the stress applying mechanism being positioned at the housing.

The passive fiber optic cabinet according to the embodiments of the present disclosure can detect the state of the door of the passive fiber optic cabinet in a field environment under a passive condition and transmit information related to the state of the door, for timely maintenance and management of the passive fiber optic cabinet, thereby ensuring safety of the passive fiber optic cabinet and fiber optic communication in a low-cost and high-reliability manner.

Note that “the state of the door” described herein means “the open state or the closed state of the door”, and “detecting the state of the door” described herein means “detecting whether the door is in the open state or the closed state”. It should also be noted that the “passive fiber optic cabinet” described in the present disclosure is not limited to the form of a cabinet, but may take any suitable form as long as it is a structure having an openable and closable cover and defining an internal space, so it may also take the form of, for example, a closure, a box, a manhole, or the like. Specific examples of the passive fiber optic cabinet described in the present disclosure may include, but are not limited to, an optical cable cross-connecting box, a fiber optic splice closure, an optical branching box, an optical fiber distribution cabinet, an optical cable manhole, and the like. The present disclosure is applicable to detection of a state of a “door” of various devices and apparatuses, and can detect whether various openable and closable structures such as doors, windows, covers, and shutters are in an open state or a closed state under a passive condition.

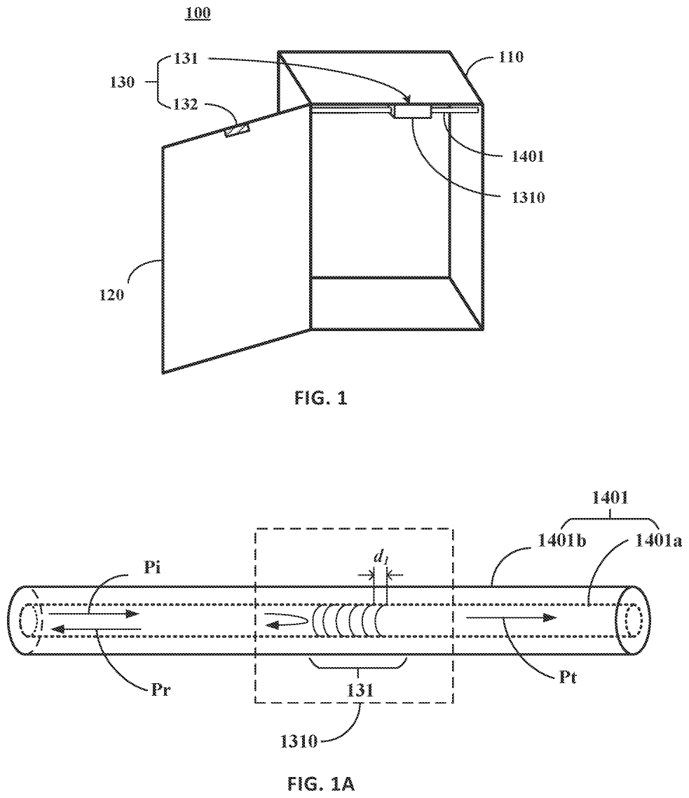

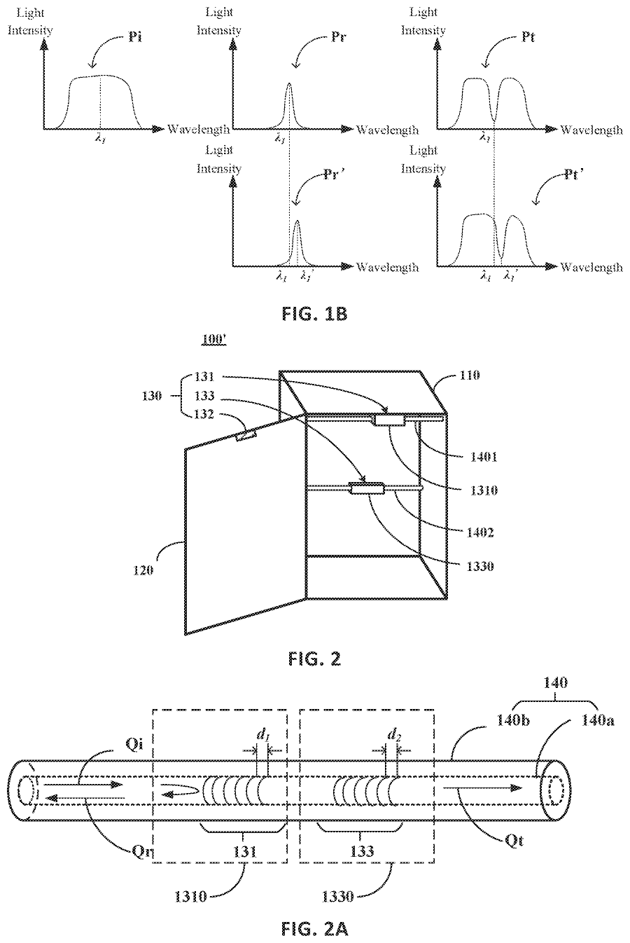

A passive fiber optic cabinet according to an embodiment of the present disclosure is described in detail below in conjunction with FIG. 1. FIG. 1 is an exemplary schematic diagram illustrating a passive fiber optic cabinet 100 according to some embodiments of the present disclosure. It should be noted that other components may be present in an actual passive fiber optic cabinet, but are not shown in the figures and discussed herein to avoid obscuring the points of the present disclosure.

The passive fiber optic cabinet 100 may comprise a housing 110 and a door 120, wherein the door 120 is coupled to the housing 110 and is configured to be switchable between an open state and a closed state. In the condition shown in FIG. 1, the door 120 is in an open state. The door 120 may enclose the housing 110 when the door 120 is in a closed state.

The passive fiber optic cabinet 100 may further comprise a switch sensor module 130 for detecting whether the door 120 of the passive fiber optic cabinet 100 is in an open state or a closed state. The switch sensor module 130 may include a detection fiber Bragg grating (FBG) sensor 131 and a stress applying mechanism 132 corresponding to the detection FBG sensor 131.

The FBG sensor (e.g., the detection FBG sensor, a reference FBG sensor described later) may be designed to reflect a predetermined wavelength (hereinafter referred to as a predetermined reflection wavelength). When the FBG sensor is affected by a stress and/or temperature change, the wavelength actually reflected by the FBG sensor may deviate from a designed predetermined reflection wavelength. In some embodiments, the detection FBG sensor 131 may be disposed in an optical fiber and may be configured to receive light including a detection wavelength associated with the detection FBG sensor 131 from an external light source via the optical fiber. In some embodiments, the detection wavelength may be a predetermined reflection wavelength of the detection FBG sensor 131. In some embodiments, the detection wavelength may be a predetermined wavelength that is reflected by the detection FBG sensor 131 under a predetermined stress and/or temperature condition.

In some embodiments, the detection wavelength may include at least one of a first detection reflection wavelength reflected by the detection FBG sensor 131 when the detection FBG sensor 131 is in a first stress state and/or a second detection reflection wavelength reflected by the detection FBG sensor 131 when the detection FBG sensor 131 is in a second stress state, wherein the first stress state may be a stress state of the detection FBG sensor 131 when the door 120 is in one of the closed state or the open state, and the second stress state may be a stress state of the detection FBG sensor 131 when the door 120 is in the other of the closed state or the open state.

For example, referring to FIG. 1 in combination with FIG. 1A, an optical fiber 1401 may include a core 1401a and a cladding layer 1401b, and the detection FBG sensor 131 may be disposed in the core 1401a of the optical fiber 1401. In some embodiments, the first and/or second detection reflection wavelengths may depend on a refractive index n of the core 1401a of the optical fiber 1401 and a grating period d₁ of the detection FBG sensor 131. In some examples, the first or second detection reflection wavelength may be equal to twice a product of the refractive index n of the core 1401a of the optical fiber 1401 and the grating period d₁ of the detection FBG sensor 131.

In some embodiments, the first and/or the second detection reflection wavelength may also depend on a temperature of an environment in which the passive fiber optic cabinet is located. For example, in some embodiments, one day may be divided into a plurality of time intervals according to temperature changes of the environment in which the passive fiber optic cabinet is located within one day, a temperature variance within each time interval being less than a predetermined threshold, and the first and/or the second detection reflection wavelengths within each time interval also depend on an average temperature within the time interval. For those passive fiber optic cabinets whose environmental temperature is liable to change, by calculating the first and/or second detection reflection wavelengths in consideration of an influence of the temperature on the actual reflection wavelength of the detection FBG sensor 131 to adjust the wavelength of light provided by the external light source, it is possible to more accurately determine the stress state of the detection FBG sensor to thereby determine whether the door of the passive fiber optic cabinet is in the open state or the closed state, which can exclude misjudgment due to temperature changes.

For example, assuming that Pi denotes the light incident to the detection FBG sensor 131, Pr denotes the light reflected by the detection FBG sensor 131, and Pt denotes the light transmitted from the detection FBG sensor 131, in case where the incident light Pi includes a detection wavelength corresponding to a first detection reflection wavelength λ₁, in the example shown in FIG. 1B, a peak wavelength of the reflected light Pr is λ₁, and spectral lines of the transmitted light Pt are the result of subtracting spectral lines of the reflected light Pr from spectral lines of the incident light Pi. Therefore, when the reflected light Pr is transmitted to a remote processing terminal, the remote processing terminal can determine that the detection FBG sensor 131 is in the first stress state by determining that the peak wavelength of the reflected light Pr includes the first detection reflection wavelength λ₁, and thereby can determine that the door 120 is in one of the open state and the closed state corresponding to the first stress state. Herein, since it is considered that a monochromatic light having an absolutely single wavelength is generally absent but various wavelength components are still contained in a narrow wavelength range, the wavelength of the reflected light is represented by its peak wavelength, and “determining a wavelength of the reflected light” described herein generally refers to determining a wavelength at a peak position of the spectrum of the reflected light.

The stress applying mechanism 132 may be configured to apply a stress to the detection FBG sensor 131. As such, the detection FBG sensor 131 and the stress applying mechanism 132 may be configured such that the stress applied to the detection FBG sensor 131 by the stress applying mechanism 132 is different when the door 120 is in the closed state from when the door is in the open state. In some embodiments, the detection FBG sensor 131 and the stress applying mechanism 132 may be configured such that an absolute value of a difference in the stresses applied to the detection FBG sensor 131 by the stress applying mechanism 132 when the door 120 is in the closed state and when the door is in the open state is greater than a predetermined stress difference threshold. In other words, in some embodiments, an absolute value of a difference in the stresses received by the detection FBG sensor 131 in the first stress state and in the second stress state is greater than a predetermined stress difference threshold. In some embodiments, the detection FBG sensor 131 and the stress applying mechanism 132 may be configured such that no stress is applied to the detection FBG sensor 131 by the stress applying mechanism 132 when the door 120 is in one of the closed state and the open state, and a stress is applied to the detection FBG sensor 131 by the stress applying mechanism 132 when the door 120 is in the other of the closed state and the open state. In other words, in some embodiments, no stress is applied to the detection FBG sensor 131 in the first stress state and a stress is applied to the detection FBG sensor 131 in the second stress state.

One of the detection FBG sensor 131 and the stress applying mechanism 132 may be positioned at the door 120, and the other may be positioned at the housing 110. In the example shown in FIG. 1, the stress applying mechanism 132 is positioned at the door 120 and the detection FBG sensor 131 is positioned at the housing 110, but this is merely exemplary but not restrictive. In other examples, the stress applying mechanism 132 may be positioned at the housing 110 and the detection FBG sensor 131 may be positioned at the door 120. For example, in some embodiments, the positions of the detection FBG sensor 131 and the stress applying mechanism 132 may be configured such that the detection FBG sensor 131 and the stress applying mechanism 132 overlap each other when the door 120 is in the closed state. In some embodiments, the positions of the detection FBG sensor 131 and the stress applying mechanism 132 may be configured such that a distance between the detection FBG sensor 131 and the stress applying mechanism 132 does not exceed a predetermined distance threshold when the door 120 is in the closed state. In some embodiments, the positions of the detection FBG sensor 131 and the stress applying mechanism 132 may be configured such that the detection FBG sensor 131 and the stress applying mechanism 132 contact each other when the door 120 is in the closed state.

Since the stress applied to the detection FBG sensor 131 by the stress applying mechanism 132 is different when the door 120 is in the closed state from when the door is in the open state, when the door 120 is switched between the open state and the closed state, wavelengths of the light actually reflected by the detection FBG sensor 131 are different from each other. For example, referring to FIG. 1B, when the light provided by the external light source includes a first detection reflection wavelength λ₁ and a second detection reflection wavelength λ₁′, the peak wavelength of the reflected light Pr reflected by the detection FBG sensor 131 is the first detection reflection wavelength λ₁ when the detection FBG sensor 131 is in the first stress state, and the peak wavelength of the reflected light Pr′ reflected by the detection FBG sensor 131 is changed to the second detection reflection wavelength λ₁′ when the detection FBG sensor 131 is changed from the first stress state to the second stress state, and an intensity of the transmitted light Pr′ transmitted from the detection FBG sensor 131 at λ₁′ (instead of λ₁) is greatly reduced. Thus, when the reflected light is transmitted to the remote processing terminal, the remote processing terminal can determine whether the detection FBG sensor 131 is in the first or second stress state by determining whether the peak wavelength of the reflected light Pr is the first or second detection reflection wavelength λ₁ or λ₁′, and thereby can determine whether the door 120 is in the open state or the closed state.

It will be appreciated that, when the light provided by the external light source includes only one of the first detection reflection wavelength λ₁ and the second detection reflection wavelength λ₁′, for example, taking the example that the light provided by the external light source includes the first detection reflection wavelength λ₁ and does not include the second detection reflection wavelength λ₁′, if it is determined that the wavelength of the reflected light includes the first detection reflection wavelength λ₁ (i.e., the spectrum of the reflected light has a peak at λ₁), then it can be determined that the detection FBG sensor 131 is in the first stress state; in contrast, if it is determined that the wavelength of the reflected light does not include the first detection reflection wavelength λ₁ (i.e., the spectrum of the reflected light does not have a peak at λ₁), then it can be determined that the detection FBG sensor 131 is in the second stress state. In particular, when the light provided by the external light source is monochromatic light including only one of the first detection reflection wavelength λ₁ and the second detection reflection wavelength λ₁′, if a reflected light is present, then it can be determined that the detection FBG sensor 131 is in a stress state corresponding to the one detection reflection wavelength; in contrast, if a reflected light is not present, then it can be determined that the detection FBG sensor 131 is in the other stress state.

It will be appreciated that, in addition to determining the state of the door from the absolute value of the detection reflection wavelength, a change in the state of the door may also be determined from a relative value of the change in the detection reflection wavelength. In some embodiments, the passive fiber optic cabinet 100 may be continuously or periodically provided with detection light. For example, when the passive fiber optic cabinet 100 is normally in a state where the door is closed at ordinary times, if a change in the wavelength of the reflected light is detected as compared to the wavelength of the reflected light previously received (e.g., the reflected light received in the last detection period, etc.), it may be determined that the door may be opened.

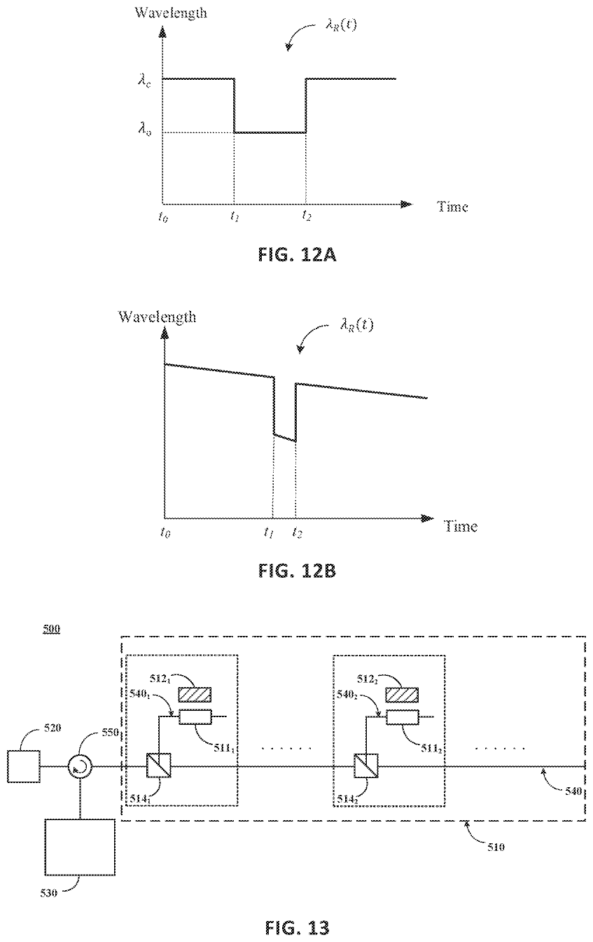

For example, referring to FIG. 12A, taking the case where the stress applied to the detection FBG sensor 131 by the stress applying mechanism 132 may be greater when the door 120 is in the closed state than when the door 120 is in the open state as an example, a detection reflection wavelength λ_{c} when the door 120 is in the closed state is larger than a detection reflection wavelength λₒ when the door 120 is in the open state. In this case, if the passive fiber optic cabinet 100 is continuously provided with detection light including, for example, at least a wavelength range from λₒ to λ_{c}, and a wavelength of the received reflected light as a function of time (λ_{R}(t)) is recorded, it can be seen from FIG. 12A that, the wavelength of the reflected light is maintained at λ_{c} during a period from t₀ to t₁, showing that the door 120 of the passive fiber optic cabinet 100 is in the closed state normally during this period, and the wavelength of the reflected light changes from λ_{c} to λₒ at time t₁ and changes from λₒ to λ_{c} at time t₂, showing that the door 120 of the passive fiber optic cabinet 100 is opened at time t₁ and is closed again at time t₂.

If an influence of temperature variations on the reflected wavelength of the detection FBG sensor 131 is considered on the basis of the embodiment shown in FIG. 12A (the temperature varies usually slowly, and a magnitude of a variation of the reflected wavelength related to the temperature variation is relatively small over a relatively large timescale), referring to FIG. 12B, assuming that a temperature of an environment where the passive fiber optic cabinet 100 is present decreases gradually (e.g., the air temperature becomes lower gradually after the sun goes down), the wavelength of the reflected light also decreases gradually with a relatively small slope (dλ_{R}(t)/dt) during a period from t₀ to t₁, however, the wavelength of the reflected light drops abruptly at time t₁

$$( \vert \frac{d {λ}_{R} ( t )}{dt} {\vert}_{t = t 1} \vert ≫ \vert \frac{d {λ}_{R} ( t )}{dt} {\vert}_{t = t 1 - Δ t} \vert , and \frac{d {λ}_{R} ( t )}{dt} {\vert}_{t = t 1} < 0 ) ,$$

showing that the door 120 of the passive fiber optic cabinet 100 is opened abruptly at this time, whereas the wavelength of the reflected light rises again abruptly at time t₂

$$( \vert \frac{d {λ}_{R} ( t )}{dt} {\vert}_{t = t 2} \vert ≫ \vert \frac{d {λ}_{R} ( t )}{dt} {\vert}_{t = t 22 - Δ t} \vert , and \frac{d {λ}_{R} ( t )}{dt} {\vert}_{t = t 2} > 0 ) ,$$

showing that the door 120 of the passive fiber optic cabinet 100 is closed again at this time. As such, a variation of a state of the door can be identified in the background of a relatively steadily varying λ_{R}(t) typically caused by temperature variations by observing the rate of change of the wavelength of the reflected light over time (dλ_{R}(t)/dt) (a magnitude of a variation of the reflected wavelength related to the variation of the state of the door is large over a relatively small timescale). A time point corresponding to a large value of dλ_{R}(t)/dt may correspond to a time point at which the state of the door is switched, and it may be determined whether the door changes from being open to being closed or from being closed to being open at that time point considering in conjunction with the plus or minus characteristic of dλ_{R}(t)/dt. This can avoid misjudgments caused by temperature variations and improve the accuracy of the detection result. Therefore, in some embodiments, whether the door of the passive fiber optic cabinet is in an open state or a closed state may be determined based on a variation of the determined wavelength of the reflected light over time.

Additionally, in some embodiments, for example, with reference to FIG. 1 in combination with FIG. 1A, where the optical fiber 1401 is provided with the detection FBG sensor 131, a package component 1310 may be provided outside the optical fiber 1401 around the detection FBG sensor 131, and the package component 1310 may be configured such that properties of the FBG sensor inside the optical fiber 1401 will not be affected by any external bending, stretching, squeezing or twisting strain, and/or may be configured to isolate heat exchange between the inside and the outside of the package component 1310 such that the FBG sensor inside the optical fiber 1401 will not be affected by external temperature changes. By providing the package component 1310, the detection FBG sensor 131 is only subjected to the stress applied by the stress applying mechanism 132, and is not affected by the external temperature or other stresses, thereby improving the accuracy and reliability of the detection.

In some embodiments, the stress applied to the detection FBG sensor 131 by the stress applying mechanism 132 may be greater when the door 120 is in the closed state than when the door 120 is in the open state. In some examples, the stress applying mechanism 132 may include a magnet. Accordingly, a magnetically attractable material may be applied, such as wrapping a metal coil, disposing a metal patch, disposing opposing magnets, etc., to the optical fiber 1401 at a location where the detection FBG sensor 131 is disposed. In embodiments in which the package component 1310 is provided, the magnetically attractable material may be included in the package component 1310.

In some embodiments, the stress applied to the detection FBG sensor 131 by the stress applying mechanism 132 may be smaller when the door 120 is in the closed state than when the door 120 is in the open state. In some examples, the stress applying mechanism 132 may include a spring attached to the detection FBG sensor 131. When the door 120 is in the closed state, the spring is in a relaxed state, and it is detected at this time that the FBG sensor 131 is not under a tension of the spring or the tension is below a predetermined tension threshold; when the door 120 is in the open state, the spring is in a tensioned state, and the detection FBG sensor 131 is under the tension of the spring or the tension is higher than the predetermined tension threshold.

Specific examples of the stress applying mechanism 132 are not limited to the above-described embodiments as long as the detection FBG sensor 131 is in different stress states under the open state and the closed state of the door 120.

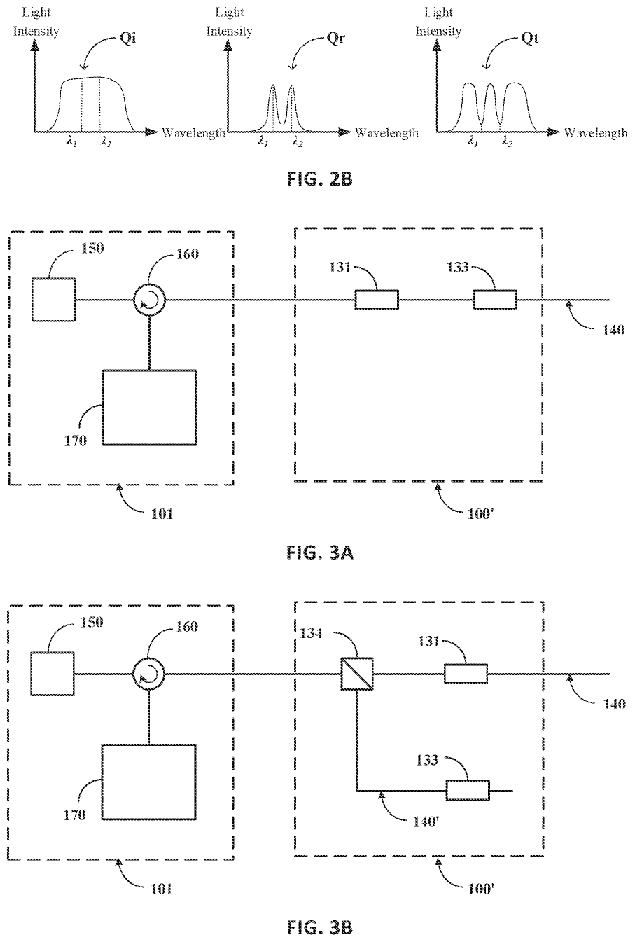

FIG. 2 is an exemplary schematic diagram illustrating a passive fiber optic cabinet 100′ according to some embodiments of the present disclosure, wherein a door of the passive fiber optic cabinet 100′ is in an open state. The passive fiber optic cabinet 100′ may have the same configuration as the passive fiber optic cabinet 100, except that it further includes a reference FBG sensor.

In some embodiments, the switch sensor module 130 of the passive fiber optic cabinet 100′ may include a reference FBG sensor 133 corresponding to the detection FBG sensor 131. The reference FBG sensor 133 is positioned at the passive fiber optic cabinet 100′ at a position at which a temperature is substantially the same as a temperature at the position of the detection FBG sensor 131 but no stress is applied to the reference FBG sensor 133 by the stress applying mechanism 132. As used herein, the phrase “a temperature is substantially the same” means a temperature differs by no more than ±10° C., preferably by no more than ±5° C., more preferably by no more than ±1° C. The reference FBG sensor 133 is used for temperature compensation, and by considering the detection results of the detection FBG sensor 131 and the reference FBG sensor 133 in combination, misjudgments on the state of the door due to temperature changes can be eliminated, to further improve the accuracy of detection.

In some embodiments, the reference FBG sensor 133 may be disposed in an optical fiber 1402 and may be configured to receive light including a reference wavelength associated with the reference FBG sensor 133 from an external light source via the optical fiber. In some embodiments, the reference wavelength may include a predetermined wavelength that is reflected by the reference FBG sensor 133. In some embodiments, the reference wavelength may include at least one of reference reflection wavelengths that are reflected by the reference FBG sensor 133 under different temperature states. In some embodiments, the different temperature states may include a daytime temperature state and a nighttime temperature state.

When the optical fibers 1401 and 1402 belong to different fibers (i.e. without any common optical path), the reference wavelength may be the same as or different from the detection wavelength. When the optical fibers 1401 and 1402 belong to the same fiber (i.e. with a common optical path), the reference wavelength may be different from the detection wavelength.

In some embodiments, the wavelength of light reflected by the detection FBG sensor is in a first wavelength range, the wavelength of light reflected by the reference FBG sensor is in a second wavelength range, and the first wavelength range and the second wavelength range do not overlap. Thus, even if the stress and/or temperature changes, the wavelengths of the light reflected by the detection FBG sensor and the light reflected by the reference FBG sensor will not be the same at all times. In some embodiments, the light provided by the external light source to the detection FBG sensor and the reference FBG sensor may include the first wavelength range and the second wavelength range.

Additionally, in some embodiments, for example, referring to FIG. 2 in combination with FIG. 2A, where the optical fiber 1402 is provided with the reference FBG sensor 133, a package component 1330 may also be provided outside the optical fiber 1402 around the reference FBG sensor 133, the package component 1330 may be configured such that the properties of the FBG sensor inside the optical fiber 1402 are not affected by any external bending, stretching, squeezing or twisting strain, and/or may be configured to isolate heat exchange between the inside and the outside of the package component 1330 such that the FBG sensor inside the optical fiber 1402 is not affected by external temperature changes. By providing the package component 1330, the reference signal provided by the reference FBG sensor 133 has a higher reliability, thereby improving the accuracy of the detection.

In some embodiments, the reference FBG sensor 133 is disposed in the same optical fiber as the detection FBG sensor 131, wherein the reference wavelength is different from the detection wavelength. For example, referring to FIGS. 2A and 3A, the reference FBG sensor 133 and the detection FBG sensor 131 are disposed in a same optical fiber 140. The optical fiber 140 may include a core 140a and a cladding layer 140b, and the reference FBG sensor 133 and the detection FBG sensor 131 may be disposed in the core 140a. Referring to FIG. 2B in combination with FIG. 3A, assuming that light incident to the reference FBG sensor 133 and the detection FBG sensor 131 is denoted by Qi, light reflected by the reference FBG sensor 133 and the detection FBG sensor 131 is denoted by Qr, and light transmitted from the reference FBG sensor 133 and the detection FBG sensor 131 is denoted by Qt, light Qi from an external light source 150 including a detection wavelength λ₁ and a reference wavelength λ₂ different from the detection wavelength λ₁ reaches the detection FBG sensor 131 and the reference FBG sensor 133 through the optical fiber 140 via an optical circulator 160, and then a part thereof is reflected by the detection FBG sensor 131 and the reference FBG sensor 133, the reflected light Qr is transmitted to an external processing device 170 through the optical fiber 140 via the optical circulator 160, and the external processing device 170 determines whether the door 120 is in an open state or a closed state by determining wavelengths of the reflected light Qr and comparing the wavelengths of the reflected light Qr with wavelengths expected to be reflected by the detection FBG sensor 131 and the reference FBG sensor 133.

For example, as shown in FIG. 2B, assuming that the door 120 of the passive fiber optic cabinet 100′ is in a closed state and the passive fiber optic cabinet 100′ is in a relatively stable temperature environment for a certain period of time, the wavelengths of the reflected light Qr at this time are determined to include λ₁ and λ₂ (i.e., the spectrum of the reflected light Qr has peaks at both λ₁ and λ₂). After a period of time has elapsed, by determining the wavelengths of the reflected light Qr, it is found that the wavelength of the light reflected by the detection FBG sensor 131 is shifted (the spectrum of the reflected light Qr no longer has a peak at λ₁). If the wavelength of the light reflected by the reference FBG sensor 133 does not change at this time (i.e., the spectrum of the reflected light Qr still has a peak at λ₂), it can be determined that the door 120 is opened; if the wavelength of the light reflected by the reference FBG sensor 133 is also shifted (the spectrum of the reflected light Qr no longer has a peak at λ₂) and the amount of shift is substantially the same as the amount of shift of the wavelength of the light reflected by the detection FBG sensor 131, it can be determined that the door 120 is still closed but the environmental temperature is changed.

In some embodiments, the external light source 150, the optical circulator 160, and the external processing device 170 may be remotely positioned relative to the passive fiber optic cabinet 100′, e.g., they may be located at a remote processing terminal 101.

In some embodiments, the passive fiber optic cabinet 100′ may further comprise a beam splitter configured to branch off at least one branch fiber from the optical fiber where the detection FBG sensor is disposed, wherein the reference FBG sensor may be disposed in one of the at least one branch fiber, and wherein the reference wavelength is different from the detection wavelength. Referring to FIG. 3B, the passive fiber optic cabinet 100′ includes a beam splitter 134 that branches off a branch fiber 140′ from the optical fiber 140, and the reference FBG sensor 133 is disposed in the branch fiber 140′. Further, when a time delay means such as a signal delay line is disposed in an optical path between the reference FBG sensor 133 and the beam splitter 134, the reference wavelength may be the same as the detection wavelength. At this time, although the reflected lights from the detection FBG sensor 131 and the reference FBG sensor 133 are not distinguishable in terms of their wavelengths, they are distinguishable in terms of time.

Although FIGS. 1 and 2 show only one detection FBG sensor 131, one stress applying mechanism 132 and/or one reference FBG sensor 133, this is merely exemplary but not restrictive, and any number of detection FBG sensors 131, stress applying mechanisms 132 and/or reference FBG sensors 133 may be provided in the passive fiber optic cabinet 100, 100′ as desired for detecting one or more doors of the passive fiber optic cabinet 100, 100′. In this case, the detection FBG sensors 131, the stress applying mechanisms 132, and the reference FBG sensors 133 may adopt a one-to-one correspondence, or a one-to-many correspondence. For example, as a non-limiting example, in the case where the passive fiber optic cabinet 100′ has a plurality of doors, each door may be provided with one detection FBG sensor 131, and one stress applying mechanism 132 and one reference FBG sensor 133 may be provided at the housing to be shared by the detection FBG sensors 131 at each door.

In some embodiments, when the optical fiber where the detection FBG sensor (and/or the reference FBG sensor, if provided) is disposed is an optical fiber for fiber optic communication of the passive fiber optic cabinet, the detection wavelength (and/or the reference wavelength, if a reference FBG sensor is provided) is outside an operating wavelength range for the fiber optic communication. In some embodiments, when the optical fiber where the detection FBG sensor (and/or the reference FBG sensor, if provided) is disposed is not an optical fiber for fiber optic communication of the passive fiber optic cabinet, the detection wavelength (and/or the reference wavelength, if a reference FBG sensor is provided) can be in any suitable wavelength range. In some embodiments, the detection wavelength (and the reference wavelength, if a reference FBG sensor is provided) may be in a range from 1530 nm to 1565 nm (i.e., C-band). The choice of the C-band is advantageous in that optical fibers for C-band are commonly employed and inexpensive. In some embodiments, the detection wavelength (and the reference wavelength, if a reference FBG sensor is provided) may be in a range from 900 nm to 1200 nm.

Note that, although it is described above that the detection wavelength and/or the reference wavelength may correspond to the wavelength of the light reflected by the detection FBG sensor 131 and/or the reference FBG sensor 133 under one of the open state or the closed state of the door, respectively, it should be understood that a predetermined detection wavelength (or detection wavelength range) and/or a predetermined reference wavelength (or reference wavelength range) may be assigned in advance to the detection FBG sensor 131 and/or the reference FBG sensor 133, respectively, and then the detection FBG sensor 131 and/or the reference FBG sensor 133 may be designed based on the predetermined detection wavelength (or detection wavelength range) and/or the predetermined reference wavelength (or reference wavelength range), respectively, e.g., a grating period of the FBG sensor and/or a core refractive index of the optical fiber where the FBG sensor is disposed may be designed. For example, if the C-band is used for the detection of the state of the door of the passive fiber optic cabinet, a wavelength range of 1531 nm to 1536 nm may be assigned to the passive fiber optic cabinet, wherein a wavelength range of 1531 nm to 1533 nm is assigned to the detection FBG sensor 131 (which may correspond to the aforementioned first wavelength range), a wavelength range of 1534 nm to 1536 nm is assigned to the reference FBG sensor 133 (which may correspond to the aforementioned second wavelength range), and then the detection FBG sensor 131 and the reference FBG sensor 133 are designed according to the respective wavelength ranges. A width of the wavelength range assigned to each FBG sensor may depend on a stress range to which the FBG sensor is subjected and/or a temperature range at which the FBG sensor is exposed, such that the wavelength reflected by the FBG sensor is always within the assigned wavelength range. Wavelength ranges assigned to different FBG sensors may not overlap each other. In the case where the wavelength ranges assigned to the detection FBG sensor 131 and the reference FBG sensor 133 do not overlap each other, if it is determined that no signal is detected in at least one of the assigned wavelength ranges (i.e., none of wavelengths of the reflected lights falls in that wavelength range), it shows that an abnormality occurs in the FBG sensor corresponding to the at least one of the assigned wavelength ranges (the detection FBG sensor 131 and/or the reference FBG sensor 133), a stress range and/or a temperature range to which the FBG sensor is subjected exceeds a normal range (e.g., abnormalities such as the passive fiber optic cabinet being on fire, being hit, and the like), at this time an alarm may be issued in response to no signal being detected in at least one of the assigned wavelength ranges so as to alert related personnel to check.

Another aspect of the present disclosure provides a system for detecting a state of a door of a passive fiber optic cabinet, comprising: a plurality of passive fiber optic cabinets, each being a passive fiber optic cabinet according to any embodiment of the present disclosure; a light source module configured to provide light including detection wavelengths associated with the detection FBG sensors to the detection FBG sensors; and an analysis module configured to receive reflected lights reflected by the detection FBG sensors, determine wavelengths of the reflected lights, and determine whether the doors of the passive fiber optic cabinets are in an open state or a closed state based on the determined wavelengths of the reflected lights.

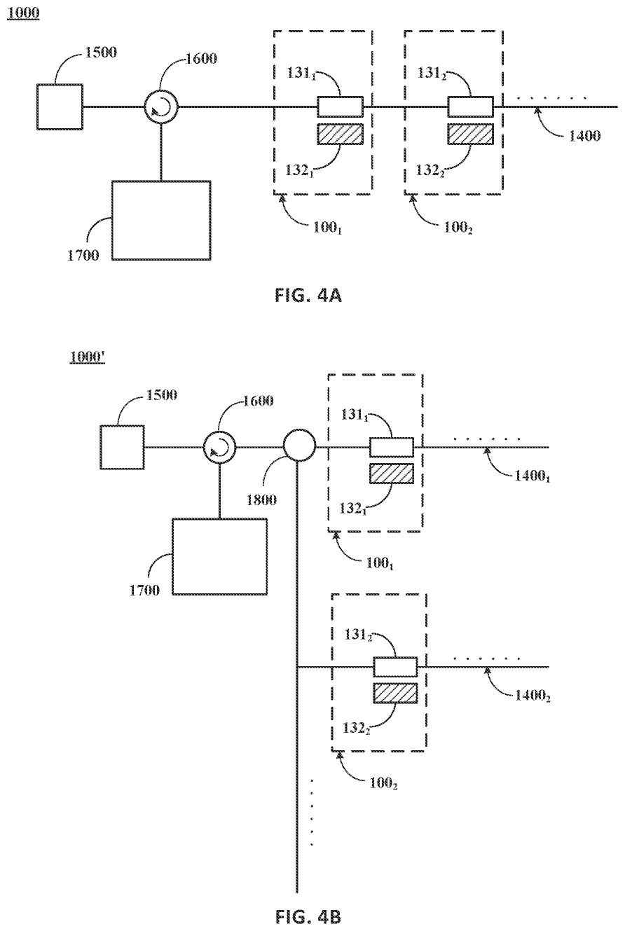

A system 1000 for detecting a state of a door of a passive fiber optic cabinet comprising the above-described passive fiber optic cabinet according to the embodiments of the present disclosure is described in detail below in conjunction with FIGS. 4A and 4B. It should be noted that other components may be present in an actual system for detecting a state of a door of a passive fiber optic cabinet, but are not shown in the figures and discussed herein in order to avoid obscuring the points of the present disclosure.

As shown in FIG. 4A, the system 1000 may comprise a plurality of passive fiber optic cabinets 100₁, 100₂, . . . , each of which may be a passive fiber optic cabinet 100 or 100′ as described above according to the embodiments of the present disclosure. That is, any of the embodiments described above with respect to the passive fiber optic cabinet 100 or 100′ are applicable to the passive fiber optic cabinets comprised in the system 1000. Although the passive fiber optic cabinets 100₁, 100₂ (and optionally more passive fiber optic cabinets) are depicted in FIG. 4A to only comprise the detection FBG sensors 131₁, 131₂ and the corresponding stress applying mechanisms 132₁, 132₂, it will be appreciated that they may optionally also comprise reference FBG sensors. The description of the reference FBG sensor is similar to the reference FBG sensor 133 previously described with respect to the passive fiber optic cabinet 100′ and will not be repeated here. It will be appreciated that each passive fiber optic cabinet of the system 1000 need not have the same configuration. In some embodiments, one or more of the plurality of passive fiber optic cabinets of the system 1000 may comprise a reference FBG sensor. For example, a reference FBG sensor can be provided for a passive fiber optic cabinet whose environmental temperature changes greatly.

The system 1000 may also comprise a light source module 1500. The light source module 1500 can be configured to provide, to the detection FBG sensors of the plurality of passive fiber optic cabinets, light including detection wavelengths associated with the detection FBG sensors. In some embodiments, the detection wavelengths may include predetermined reflection wavelengths of the detection FBG sensors 131₁, 131₂, . . . . In some embodiments, the detection wavelengths may include predetermined wavelengths reflected by the detection FBG sensors 131₁, 131₂, . . . under predetermined stress and/or temperature conditions. In some embodiments, the detection wavelengths may include first detection reflection wavelengths reflected by the detection FBG sensors 131₁, 131₂, . . . when the detection FBG sensors 131₁, 131₂, . . . are in a first stress state and/or second detection reflection wavelengths reflected by the detection FBG sensors 131₁, 131₂, . . . when the detection FBG sensors 131₁, 131₂, . . . are in a second stress state, wherein the first stress state may be a stress state of the detection FBG sensors 131₁, 131₂, . . . when the doors of the passive fiber optic cabinets are in one of the closed state or the open state, and the second stress state may be a stress state of the detection FBG sensors 131₁, 131₂, . . . when the doors of the passive fiber optic cabinets are in the other of the closed state or the open state. In some embodiments, the detection FBG sensors are disposed in an optical fiber(s), and the light source module 1500 is configured to provide light to the detection FBG sensors via the optical fiber(s). In some embodiments, the light source module 1500 may include at least one of: a broadband light source, a tunable laser source, and a combination of a plurality of narrow-band light sources. In some embodiments, the light output by the light source module 1500 may range in wavelength from 1530 nm to 1565 nm.

The system 1000 may further comprise an analysis module 1700. The analysis module 1700 may be configured to receive reflected lights reflected by the detection FBG sensors, determine wavelengths of the reflected lights, and determine whether the doors of the passive fiber optic cabinets are in an open state or a closed state based on the determined wavelengths of the reflected lights. In some embodiments, the analysis module 1700 may be configured to determine whether the doors of the passive fiber optic cabinets are in an open state or a closed state based on variations of the determined wavelengths of the reflected lights over time. Specific implementations of the analysis module 1700 to determine the state of the door based on the wavelength of the reflected light may refer to the previous description of all embodiments for determining the state of the door based on the wavelength of the reflected light, and the analysis module 1700 may be similar to an analysis module 230 to be described later, and thus the details will not be repeated herein.

As shown in FIG. 4A, the detection FBG sensors 131₁, 131₂, . . . may be disposed in an optical fiber 1400, light from the light source module 1500 reaches the detection FBG sensors 131₁, 131₂, . . . through the optical fiber 1400 via an optical circulator 1600, and reflected lights reflected by the detection FBG sensors 131₁, 131₂, . . . reach the analysis module 1700 via the optical circulator 1600.

In some embodiments, the detection FBG sensors of the plurality of passive fiber optic cabinets may be disposed in the same optical fiber (e.g., in the configuration shown in FIG. 4A), and the detection wavelengths associated with the respective detection FBG sensors are different from each other.

Additionally, FIG. 4B illustrates another configuration 1000′ of the system 1000. In some embodiments, the plurality of passive fiber optic cabinets comprised in the system 1000′ may include a first group of passive fiber optic cabinets 100₁, . . . and a second group of passive fiber optic cabinets 100₂, . . . , wherein the detection FBG sensors of each of the first group of passive fiber optic cabinets 100₁, . . . are disposed in a first optical fiber 1400₁ and the detection wavelengths associated with the respective detection FBG sensors of the first group of passive fiber optic cabinets 100₁, . . . are different from each other, and wherein the detection FBG sensors of each of the second group of passive fiber optic cabinets 100₂, . . . are disposed in a second optical fiber 1400₂ different from the first optical fiber 1400₁ and the detection wavelengths associated with the respective detection FBG sensors of the second group of passive fiber optic cabinets 100₂, . . . are different from each other.

If the first and second optical fibers 1400₁ and 1400₂ are connected to the same optical fiber to receive light from the light source module 1500, then in some embodiments, the detection wavelengths associated with the detection FBG sensors of the first group of passive fiber optic cabinets 100₁, . . . and the detection wavelengths associated with the detection FBG sensors of the second group of passive fiber optic cabinets 100₂, . . . may be different from each other. However, in some embodiments, the detection wavelengths associated with the respective detection FBG sensors of the first group of passive fiber optic cabinets 100₁, . . . and the detection wavelengths associated with the respective detection FBG sensors of the second group of passive fiber optic cabinets 100₂, . . . may have at least one same detection wavelength.

For example, in some embodiments, the system 1000′ may also have an optical switch 1800, and the light source module 1500 may be configured to provide light to the respective detection FBG sensors of a respective group of passive fiber optic cabinets (the first group of passive fiber optic cabinets 100₁, . . . and the second group of passive fiber optic cabinets 100₂, . . . ) via a respective optical fiber (the first optical fiber 1400₁ and the second optical fiber 1400₂), respectively, through the optical switch 1800. In such an embodiment, one or more of the detection wavelengths associated with the detection FBG sensors of the first group of passive fiber optic cabinets 100₁, . . . and one or more of the detection wavelengths associated with the detection FBG sensors of the second group of passive fiber optic cabinets 100₂, . . . may be the same.

For example, in some further embodiments, the detection FBG sensors of the first group of passive fiber optic cabinets 100₁, . . . may include at least a first detection FBG sensor, the detection FBG sensors of the second group of passive fiber optic cabinets 100₂, . . . may include at least a second detection FBG sensor, the first and second detection FBG sensors configured such that a detection wavelength associated with the first detection FBG sensor is the same as a detection wavelength associated with the second detection FBG sensor, and a distance along the fiber from the first detection FBG sensor to the analysis module 1700 and a distance along the fiber from the second detection FBG sensor to the analysis module 1700 differ by at least a first threshold configured such that a time difference between when the reflected lights from the first and second detection FBG sensors are received by the analysis module 1700 is no less than a predetermined time threshold. The predetermined time threshold may be configured such that the reflected light signals from the first and second detection FBG sensors are distinguishable in terms of time. In some examples, the predetermined time threshold may be configured such that a generation process of a signal based on reflected light that arrives at the analysis module first is completed before subsequent reflected light arrives at the analysis module. In some examples, the predetermined time threshold may be configured such that analysis and processing processes of a signal based on reflected light that arrives at the analysis module first are completed before subsequent reflected light arrives at the analysis module. That is, the predetermined time threshold may be specifically set according to the time required for the analysis module to generate, analyze, and/or process a signal based on the received reflected light. For example, the predetermined time threshold may be on the order of microseconds, e.g., may be between 0.1 microseconds to 100 microseconds, or may be between 1 microseconds to 10 microseconds, etc.

It will be appreciated that the first group of passive fiber optic cabinets 100₁, . . . and the second group of passive fiber optic cabinets 100₂, . . . may not only include a respective one of a pair of such first and second detection FBG sensors, respectively, but also may include respective ones of more pairs of such first and second detection FBG sensors, respectively. For example, the first group of passive fiber optic cabinets 100₁, . . . may include detection FBG sensors 131₁, 131₃, . . . , 131₂ₖ₋₁, . . . (k being a positive integer), where the detection wavelengths associated with the detection FBG sensors 131₁, 131₃, . . . , 131₂ₖ₋₁, . . . of the first group of passive fiber optic cabinets 100₁, . . . are different from each other, and the second group of passive fiber optic cabinets 100₂, . . . may include detection FBG sensors 131₂, 131₄, . . . , 131₂ₖ, . . . (k being a positive integer), where the detection wavelengths associated with the detection FBG sensors 131₂, 131₄, . . . , 131₂ₖ, . . . of the second group of passive fiber optic cabinets 100₂, . . . are different from each other. In this case, each pair of detection FBG sensors 131₂ₖ₋₁ and 131₂ₖ are configured such that a detection wavelength associated with the detection FBG sensor 131₂ₖ₋₁ is the same as a detection wavelength associated with the detection FBG sensor 131₂ₖ, and a distance along the fiber from the detection FBG sensor 131₂ₖ₋₁ to the analysis module 1700 and a distance along the fiber from the detection FBG sensor 131₂ₖ to the analysis module 1700 differ by at least a first threshold configured such that a time difference between when the reflected lights from the detection FBG sensor 131₂ₖ₋₁ and the detection FBG sensor 131₂ₖ are received by the analysis module 1700 is no less than a predetermined time threshold. As such, reflected lights from detection FBG sensors of a same group of passive fiber optic cabinets are distinguishable in terms of their wavelengths, and reflected lights from detection FBG sensors of different groups of passive fiber optic cabinets are distinguishable in terms of time. In such embodiments, the light source module 1500 may be configured to provide a light pulse including detection wavelengths associated with the detection FBG sensors of the respective passive fiber optic cabinets to the first group of passive fiber optic cabinets 100₁, . . . and the second group of passive fiber optic cabinets 100₂, . . . , the analysis module 1700 is further configured to determine whether a passive fiber optic cabinet corresponding to the reflected light belongs to the first group of passive fiber optic cabinets 100₁, . . . or the second group of passive fiber optic cabinets 100₂, . . . based on the time at which the reflected light is received, and determine which passive fiber optic cabinet of the determined group of passive fiber optic cabinets the passive fiber optic cabinet corresponding to the reflected light is and a state of a door of the passive fiber optic cabinet based on the determined wavelength of the reflected light.

In this way, even though a width of an output wavelength range of the light source module 1500 is limited, the output wavelength range of the light source module 1500 may be multiplexed for multiple groups of passive fiber optic cabinets, such that a number of passive fiber optic cabinets that may be monitored by the system may increase without increasing the output wavelength range of the light source module 1500.

The above embodiments are merely exemplary but not restrictive, and it is understood that the plurality of passive fiber optic cabinets comprised in the system 1000′ may further include more groups of passive fiber optic cabinets, with the detection FBG sensors of different groups of passive fiber optic cabinets disposed in different optical fibers.

The connection configuration of these passive fiber optic cabinets is not particularly limited, for example, some or all of them may be independent of each other (e.g., the detection FBG sensors of each passive fiber optic cabinet are disposed in a separate optical fiber to respectively receive light from the light source module 1500), may have optical fibers connected to each other (e.g., the detection FBG sensors of each passive fiber optic cabinet are disposed in a separate branch fiber connected to a trunk fiber so as to receive light from the light source module 1500 via the trunk fiber, e.g., as shown in FIG. 4B), or may have a common optical fiber (e.g., the detection FBG sensors of all passive fiber optic cabinets are disposed in the common optical fiber to commonly receive light from the light source module 1500, e.g., as shown in FIG. 4A). In some examples, some or all of these passive fiber optic cabinets may be adjacently positioned. In some examples, some or all of these passive fiber optic cabinets may be remotely positioned from each other. In some examples, some or all of these passive fiber optic cabinets may correspond to a same fiber optic communications path. In some examples, some or all of these passive fiber optic cabinets may correspond to different fiber optic communication paths. In some examples, some or all of these passive fiber optic cabinets may be of the same type. In some examples, some or all of these passive fiber optic cabinets may be of different types. In some examples, some or all of these passive fiber optic cabinets may be an Outside Plant (OSP). In some examples, some or all of these passive fiber optic cabinets may be an Inside Plant Fiber (ISPF).

Another aspect of the present disclosure further provides a system for detecting a state of a door of a passive fiber optic cabinet, comprising: a switch sensor module including a detection FBG sensor and a stress applying mechanism corresponding to the detection FBG sensor, the stress applying mechanism configured to apply a stress to the detection FBG sensor, one of the detection FBG sensor and the stress applying mechanism being positioned at the door of the passive fiber optic cabinet, and the other of the detection FBG sensor and the stress applying mechanism being positioned at a housing of the passive fiber optic cabinet; a light source module configured to provide light including a detection wavelength associated with the detection FBG sensor to the detection FBG sensor; and an analysis module configured to receive reflected light reflected by the detection FBG sensor, determine a wavelength of the reflected light, and determine whether the door of the passive fiber optic cabinet is in an open state or a closed state based on the determined wavelength of the reflected light.

The system for detecting the state of the door of the passive fiber optic cabinet according to the embodiment of the present disclosure can detect and determine the state of the door of the passive fiber optic cabinet in a field environment under a passive condition, for timely maintenance and management of the passive fiber optic cabinet, and can be adapted to simultaneously detect the states of the doors of a plurality of passive fiber optic cabinets, thereby ensuring the safety of the passive fiber optic cabinets and fiber optic communication in a low-cost and high-reliability manner.

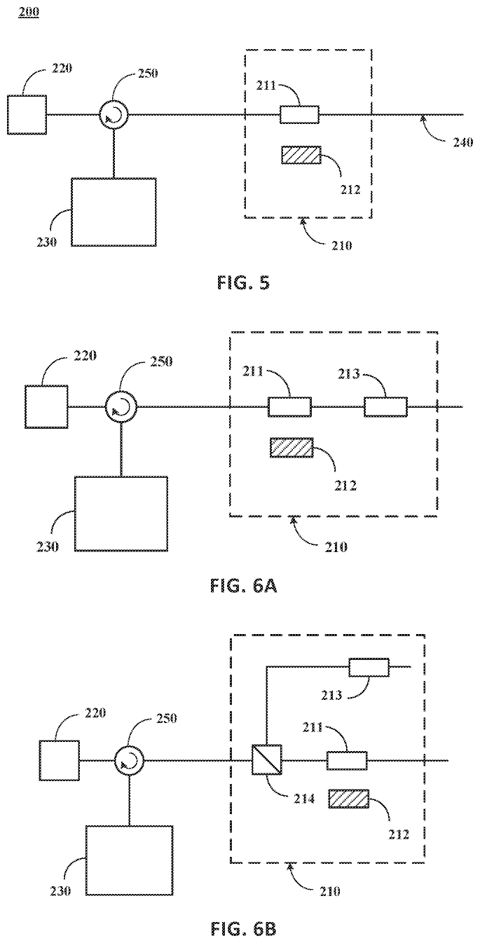

A system for detecting a state of a door of a passive fiber optic cabinet according to an embodiment of the present disclosure is described in detail below in conjunction with FIG. 5. FIG. 5 is an exemplary schematic diagram illustrating a system 200 for detecting a state of a door of a passive fiber optic cabinet according to some embodiments of the present disclosure. It should be noted that other components may be present in an actual system for detecting a state of a door of a passive fiber optic cabinet, but are not shown in the figures and discussed herein in order to avoid obscuring the points of the present disclosure.

The system 200 may comprise a switch sensor module 210. The switch sensor module 210 may include a detection FBG sensor 211 and a stress applying mechanism 212 corresponding to the detection FBG sensor 211, the stress applying mechanism 212 being configured to apply a stress to the detection FBG sensor 211, one of the detection FBG sensor 211 and the stress applying mechanism 212 being positioned at the door of the passive fiber optic cabinet, and the other of the detection FBG sensor 211 and the stress applying mechanism 212 being positioned at a housing of the passive fiber optic cabinet. The description of the switch sensor module 210 (the detection FBG sensor 211 and the stress applying mechanism 212) of the system 200 is similar to the above description of the switch sensor module 130 (the detection FBG sensor 131 and the stress applying mechanism 132) of the passive fiber optic cabinet 100, and all of the embodiments and discussions related to the latter are applicable to the switch sensor module 210 (the detection FBG sensor 211 and the stress applying mechanism 212), and are not repeated herein.

The system 200 can further include a light source module 220 configured to provide to the detection FBG sensor 211 light including a detection wavelength associated with the detection FBG sensor. In some embodiments, the detection wavelength may include a predetermined reflection wavelength of the detection FBG sensor 211. In some embodiments, the detection wavelength may include a predetermined wavelength reflected by the detection FBG sensor 211 under predetermined stress and/or temperature conditions. In some embodiments, the detection wavelength may include at least one of a first detection reflection wavelength reflected by the detection FBG sensor 211 when the detection FBG sensor 211 is in a first stress state and/or a second detection reflection wavelength reflected by the detection FBG sensor 211 when the detection FBG sensor 211 is in a second stress state, wherein the first stress state can be a stress state of the detection FBG sensor 211 when the door of the passive fiber optic cabinet is in one of the closed state or the open state, and the second stress state can be a stress state of the detection FBG sensor 211 when the door of the passive fiber optic cabinet is in the other of the closed state or the open state.

In some embodiments, the detection FBG sensor is disposed in an optical fiber, and the light source module is configured to provide light to the detection FBG sensor via the optical fiber. For example, as shown in FIG. 5, the detection FBG sensor 211 is disposed in an optical fiber 240, and light from the light source module 220 reaches the detection FBG sensor 211 through the optical fiber 240 via an optical circulator 250. In an example where the system 200 is used to detect a state of a door of one passive fiber optic cabinet, light source module 220 may include a monochromatic light source. In some embodiments, the light source module 220 may include at least one of: a broadband light source, a tunable laser source, and a combination of a plurality of narrow-band light sources. In such a case, the system 200 may be adapted to simultaneously detect the states of doors of a plurality of passive fiber optic cabinets or the states of a plurality of doors of one passive fiber optic cabinet. In some embodiments, the light output by the light source module 220 may range in wavelength from 1530 nm to 1565 nm.

The system 200 may further comprise an analysis module 230 configured to: receive reflected light reflected by the detection FBG sensor 211; determine a wavelength of the reflected light; and determine whether the door of the passive fiber optic cabinet is in an open state or a closed state based on the determined wavelength of the reflected light.

The analysis module 230 is described in detail below with reference to FIG. 9. In some embodiments, the analysis module 230 may include a photoelectric conversion unit 232 and a processing unit 233. The photoelectric conversion unit 232 may be configured to convert the reflected light reflected by the detection FBG sensor 211 into an electrical signal. The processing unit 233 may be configured to determine the wavelength of the reflected light based on the electrical signal from the photoelectric conversion unit 232. In some embodiments, the processing unit 233 can also be configured to compare the determined wavelength of the reflected light with the detection wavelength to determine whether the door of the passive fiber optic cabinet is in an open state or a closed state. In some embodiments, the processing unit 233 may also be configured to determine whether the door of the passive fiber optic cabinet is in an open state or a closed state based on a variation of the determined wavelength of the reflected light over time. Specific implementations of the processing unit 233 to determine the state of the door based on the wavelength of the reflected light may refer to any one of the embodiments for determining the state of the door based on the wavelength of the reflected light described previously with respect to the passive fiber optic cabinet according to the embodiments of the present disclosure, and will not be repeated herein.

In some embodiments, the light source module 220 may be configured to provide light continuously or periodically. In such a case, the processing unit 233 may determine a change in the wavelength of the reflected light currently received as compared to the wavelength of the reflected light previously received (e.g., the reflected light received in the last detection period, etc.), and determine a change in the state of the door based thereon.

In some embodiments, the analysis module 230 may further have a storage unit (not shown) that may store a predetermined first detection reflection wavelength of the detection FBG sensor 211 in the first stress state and a predetermined second detection reflection wavelength of the detection FBG sensor 211 in the second stress state. In some embodiments, in case where the light provided by the light source module 220 includes both the first detection reflection wavelength and the second detection reflection wavelength, in other words, in case where the detection wavelengths include both the first detection reflection wavelength and the second detection reflection wavelength, the processing unit 233 may, after determining the wavelength of the reflected light, determine whether the detection FBG sensor 211 is in the first stress state or the second stress state by retrieving the first detection reflection wavelength and the second detection reflection wavelength corresponding to the detection FBG sensor 211, stored in the storage unit, and comparing them with the determined wavelength of the reflected light. In some embodiments, in case where the light provided by the light source module 220 includes only one of the first detection reflection wavelength and the second detection reflection wavelength, the processing unit 233 may, after determining the wavelength of the reflected light, by retrieving the first detection reflection wavelength and the second detection reflection wavelength corresponding to the detection FBG sensor 211, stored in the storage unit and comparing them with the determined wavelength of the reflected light, if the determined wavelength of the reflected light includes said one of the first detection reflection wavelength and the second detection reflection wavelength (i.e. the spectrum of the reflected light has a peak at said one of the first detection reflection wavelength and the second detection reflection wavelength), determine that the detection FBG sensor 211 is in a stress state corresponding to said one of the first detection reflection wavelength and the second detection reflection wavelength; otherwise determine that the detection FBG sensor 211 is in the other stress state. In some embodiments, in case where the light provided by the light source module 220 is monochromatic light and includes only one of the first detection reflection wavelength and the second detection reflection wavelength, if the reflected light is received, it is determined that the detection FBG sensor 211 is in a stress state corresponding to said one of the first detection reflection wavelength and the second detection reflection wavelength, and if the reflected light is not received, it is determined that the detection FBG sensor 211 is in the other stress state.

In some embodiments, the light source module 220 and the analysis module 230 may be remotely positioned relative to the switch sensor module 210.

The operation process of the system for detecting the state of the door of the passive fiber optic cabinet is described below in conjunction with FIG. 10. FIG. 10 is a flowchart illustrating an exemplary method 300 for detecting a state of a door of a passive fiber optic cabinet according to some embodiments of the present disclosure. The method 300 comprises: at step S302, the light source module 220 provides to the detection FBG sensor 211 light including a detection wavelength associated with the detection FBG sensor 211; at step S304, the analysis module 230 receives the reflected light reflected by the detection FBG sensor 211; at step S306, the analysis module 230 determines a wavelength of the reflected light; and at step S308, the analysis module 230 determines whether the door of the passive fiber optic cabinet is in an open state or a closed state based on the determined wavelength of the reflected light. In some embodiments, the light source module 220 may continuously provide to the detection FBG sensor 211 light including the detection wavelength associated with the detection FBG sensor 211, while the analysis module 230 performs the steps S304 to S306, whereby real-time detection of the state of the door of the passive fiber optic cabinet can be implemented. In some embodiments, the system 200 can perform the method 300 in a predetermined period, that is, the light source module 220 periodically provides to the detection FBG sensor 211 the light including the detection wavelength associated with the detection FBG sensor 211, while the analysis module 230 performs the steps S304 to S306, whereby a relatively good monitoring effect can be achieved while saving the energy.

An exemplary configuration in which the switch sensor module 210 is provided with a reference FBG sensor 213 is described below with reference to FIGS. 6A and 6B. In some embodiments, the switch sensor module 210 may further include the reference FBG sensor 213 corresponding to the detection FBG sensor 211. The reference FBG sensor 213 is positioned at the passive fiber optic cabinet at a position at which a temperature is substantially the same as a temperature at the position of the detection FBG sensor 211 but no stress is applied to the reference FBG sensor 213 by the stress applying mechanism 212. The light source module 220 is also configured to provide to the reference FBG sensor 213 light including a reference wavelength associated with the reference FBG sensor 213. In some embodiments, the reference wavelength may include a predetermined wavelength that is reflected by the reference FBG sensor 213. In some embodiments, the reference wavelength may include at least one of reference reflection wavelengths reflected by the reference FBG sensor 213 under different temperature states. In some embodiments, the different temperature states may include a daytime temperature state and a nighttime temperature state.

Referring to FIG. 6A, in some embodiments, the reference FBG sensor 213 and the detection FBG sensor 211 may be disposed in the same optical fiber, and the reference wavelength may be different from the detection wavelength. Referring to FIG. 6B, in some embodiments, the system may further comprise a beam splitter 214 that may be configured to branch off at least one branch fiber from the optical fiber where the detection FBG sensor 211 is disposed, wherein the reference FBG sensor 213 may be disposed in one of the at least one branch fiber, and the reference wavelength may be different from the detection wavelength. Note that the reference FBG sensor 213 is similar to the reference FBG sensor 133 described above, and all of the embodiments and discussions described with respect to the latter are applicable to the reference FBG sensor 213 and are not repeated herein.

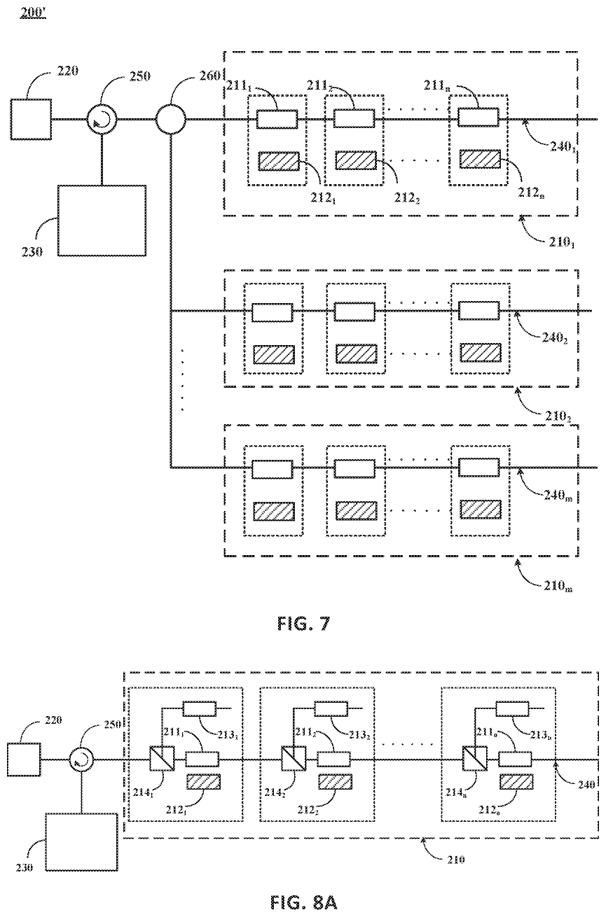

FIG. 7 describes an exemplary schematic diagram illustrating a system 200′ for detecting a state of a door of a passive fiber optic cabinet according to some embodiments of the present disclosure. In FIG. 7, dotted boxes indicate passive fiber optic cabinets and dashed boxes indicate switch sensor modules.

In some embodiments, for example, referring to FIG. 7, the system 200′ may comprise a plurality of switch sensor modules 210₁, 210₂, . . . , 210ₘ (m is an integer greater than 1), the detection FBG sensor 211 of each switch sensor module 210₁, 210₂, . . . , 210ₘ being disposed in a respective one of a plurality of optical fibers 240₁, 240₂, . . . , 240ₘ, and wherein the light source module 220 is configured to provide light to the detection FBG sensor of one of the plurality of switch sensor modules 210₁, 210₂, . . . , 210ₘ through the optical switch 260 via the respective optical fiber, respectively.

In some embodiments, each of the plurality of switch sensor modules 210₁, 210₂, . . . , 210ₘ may be disposed at a respective one of the passive fiber optic cabinets. In case where each switch sensor module has one or more detection FBG sensors (as described later), in some examples, the one or more detection FBG sensors of that switch sensor module can be used to detect the states of one or more doors of the passive fiber optic cabinet corresponding to that switch sensor module. The connection of these passive fiber optic cabinets corresponding to the plurality of switch sensor modules is not particularly limited, for example, some or all of them may be independent of each other, may have optical fibers connected to each other, or may have a common optical fiber, as previously discussed. In some examples, some or all of these passive fiber optic cabinets may be adjacently positioned. In some examples, some or all of these passive fiber optic cabinets may be remotely positioned from each other. In some examples, some or all of these passive fiber optic cabinets may correspond to a same fiber optic communication path. In some examples, some or all of these passive fiber optic cabinets may correspond to different fiber optic communication paths. In some examples, some or all of these passive fiber optic cabinets may be of the same type. In some examples, some or all of these passive fiber optic cabinets may be of different types. In some examples, some or all of these passive fiber optic cabinets may be OSP. In some examples, some or all of these passive fiber optic cabinets may be ISPF.

In some embodiments, for example, with continued reference to FIG. 7, the switch sensor module 210₁ may include a plurality of detection FBG sensors 211₁, 211₂, . . . , 211ₙ (n is an integer greater than 1) and a plurality of stress applying mechanisms 212₁, 212₂, . . . , 212ₙ corresponding to the plurality of detection FBG sensors 211₁, 211₂, . . . , 211ₙ, each detection FBG sensor 211 and the corresponding stress applying mechanism 212 may be disposed at one of a plurality of passive fiber optic cabinets for detecting a state of a door of said one passive fiber optic cabinet, the plurality of detection FBG sensors 211₁, 211₂, . . . , 211ₙ are disposed in a same optical fiber 240₁, and detection wavelengths associated with the respective detection FBG sensors 211₁, 211₂, . . . , 211ₙ are different from each other.

In some embodiments, the wavelength of light reflected by the detection FBG sensor 211ᵢ (i=1, 2, . . . , n) is within an ith wavelength range, and the ith wavelength range (i=1,2, . . . , n) does not overlap with one another. Thus, even if the stress and/or temperature change, the wavelengths of light reflected by the respective detection FBG sensors are different from each other.

The plurality of passive fiber optic cabinets corresponding to the plurality of detection FBG sensors 211₁, 211₂, . . . , 211ₙ may have a common optical fiber therebetween to be connected to each other, and the plurality of detection FBG sensors 211₁, 211₂, . . . , 211ₙ are all disposed on the common optical fiber. Such a common optical fiber may be an optical fiber dedicated to detecting the states of the doors of the passive fiber optic cabinets, in which case some or all of the plurality of passive fiber optic cabinets may correspond to a same fiber optic communication path or may correspond to different fiber optic communication paths. Such a common optical fiber may also be an optical fiber already deployed within the passive fiber optic cabinets for fiber optic communication, in which case the plurality of passive fiber optic cabinets may correspond to a same fiber optic communication path. In some examples, some or all of these passive fiber optic cabinets may be adjacently positioned. In some examples, some or all of these passive fiber optic cabinets may be remotely positioned from each other. In some examples, some or all of these passive fiber optic cabinets may be of the same type. In some examples, some or all of these passive fiber optic cabinets may be of different types. In some examples, some or all of these passive fiber optic cabinets may be OSP. In some examples, some or all of these passive fiber optic cabinets may be ISPF.

In case where the system comprises a plurality of switch sensor modules and each switch sensor module includes a plurality of detection FBG sensors, in some embodiments, each switch sensor module may be used to detect states of doors of a respective group of passive fiber optic cabinets. In some examples, some or all of each group of passive fiber optic cabinets may be adjacently positioned. In some examples, some or all of each group of passive fiber optic cabinets may correspond to a same fiber optic communication path. In some examples, some or all of each group of passive fiber optic cabinets may be of the same type.

It should be understood that although FIG. 7 shows that the number of the detection FBG sensors is the same as the number of the stress applying mechanisms and they are in one-to-one correspondence, in some embodiments, the number of the detection FBG sensors may not be the same as the number of the stress applying mechanisms, and they may not need be arranged in a one-to-one correspondence, as previously described.

In case where a plurality of detection FBG sensors are provided on one optical fiber, e.g., the plurality of detection FBG sensors 211₁, 211₂, . . . , 211ₙ are provided on the optical fiber 240₁ as shown in FIG. 7, the light source module 220 may be configured to provide light including detection wavelengths associated with the respective detection FBG sensors 211₁, 211₂, . . . , 211ₙ to the switch sensor module 210₁. And in such a case, with reference to FIG. 9, the analysis module 230 may further include a dispersing unit 231. The dispersing unit 231 may be configured to receive a plurality of reflected lights reflected by the plurality of detection FBG sensors 211₁, 211₂, . . . , 211ₙ and spatially disperse the plurality of reflected lights depending on wavelengths. The photoelectric conversion unit 232 may be configured to receive the plurality of reflected lights spatially dispersed by the dispersing unit 231 and output an electrical signal corresponding to each of the plurality of reflected lights. The processing unit 233 may be configured to determine a wavelength of each of the plurality of reflected lights based on the electrical signal from the photoelectric conversion unit 232.

In some embodiments, the dispersing unit 231 may comprise a dispersive optical element selected from a group comprising a dispersive mirror, a prism or a grating. Note that these are only non-limiting examples of the dispersing unit 231, and it will be appreciated that an optical element may be used as the dispersing unit 231 as long as it is capable of spatially separating light at different wavelengths.

Alternatively, the dispersing unit 231 may be replaced with a wavelength selective unit (not shown). In some embodiments, the analysis module includes a wavelength selective unit, a photoelectric conversion unit, and an analysis module, where the wavelength selective unit may be configured to receive a plurality of reflected lights reflected by the plurality of detection FBG sensors 211₁, 211₂, . . . , 211ₙ and selectively output one of the plurality of reflected lights, the photoelectric conversion unit 232 may be configured to receive the one reflected light output by the wavelength selective unit and output an electrical signal corresponding to the one reflected light, and the processing unit 233 may be configured to determine a wavelength of the one reflected light based on the electrical signal from the photoelectric conversion unit 232.

The wavelength selective unit may be configured to set its output wavelength to be a detection wavelength associated with each detection FBG sensors 211₁, 211₂, . . . , 211ₙ sequentially, so as to sequentially interrogate the stress state of each detection FBG sensor, thereby determining the state of the door of the respective passive fiber optic cabinet. In some embodiments, the wavelength selective unit may include a tunable filter component which are capable of adjusting a wavelength or range of wavelengths that is permitted to pass therethrough, including but not limited to a Fabry-Perot filter, a liquid crystal tunable filter (LCTF), an acoustic-optic tunable filter (AOTF), and the like. In some embodiments, the wavelength selective unit may include a light separating component which can receive and separate incident light including multiple wavelengths and only output emergent light having one of the multiple wavelengths, including but not limited to a monochromator (e.g., a grating monochromator, a prism monochromator) and the like.

In some embodiments, the photoelectric conversion unit 232 may include an array of photoelectric conversion elements, and the plurality of reflected lights reflected by the plurality of detection FBG sensors 211₁, 211₂, . . . , 211ₙ reach different photoelectric conversion elements in the array after passing through the dispersing unit 231. Specific examples of the photoelectric conversion element include, but are not limited to, a CCD and the like. For example, an exemplary operation manner of the photoelectric conversion unit 232 including the array of photoelectric conversion elements is described by taking an embodiment in which the wavelength of light reflected by the detection FBG sensors 211ᵢ (i=1,2, . . . , n) is within the i-th wavelength range and the respective i-th wavelength ranges (i=1,2, . . . , n) do not overlap each other, as an example. In some embodiments, the photoelectric conversion unit 232 may include x rows of photoelectric conversion elements, wherein

$$x = {\sum }_{i = 1}^{𝔫} {y}_{i} ,$$

where yi is a number of rows of the photoelectric conversion elements allocated to the respective detection FBG sensors 211ᵢ. Each row of photoelectric conversion elements of the photoelectric conversion unit 232 can receive light of a specific wavelength or a relatively narrow wavelength range from the dispersing unit. The rows of photoelectric conversion elements allocated to the respective detection FBG sensor 211ᵢ correspond to the i-th wavelength range, that is, the reflected light reflected by the detection FBG sensor 211ᵢ passes through the dispersing unit 231 and then reaches the rows of photoelectric conversion elements corresponding to the detection FBG sensor 211ᵢ in the photoelectric conversion unit 232. The reflected light reflected by the detection FBG sensor 211ᵢ when the door is in the open state and the reflected light reflected by the detection FBG sensor 211ᵢ when the door is in the closed state reach different rows of photoelectric conversion elements corresponding to the detection FBG sensor 211ᵢ after passing through the dispersing unit 231. Thus, the processing unit 233 can determine the wavelength of the reflected light reflected by each detection FBG sensor 211ᵢ and a change thereof based on a signal output from each row of the photoelectric conversion unit 232, thereby determining the state of the door of the corresponding passive fiber optic cabinet. In some embodiments, the number yi of the rows of photoelectric conversion elements allocated to the respective detection FBG sensors 211ᵢ may be the same as each other.

When the light source module 220 is a light source capable of adjusting an output wavelength, such as a tunable laser source, a combination of a plurality of narrow-band light sources, etc., the dispersing unit 231 may also be optionally omitted, in which case, the light source module 220 may be controlled to sequentially emit light corresponding to the detection wavelengths associated with the respective detection FBG sensors 211₁, 211₂, . . . , 211ₙ, so as to sequentially interrogate the stress state of each detection FBG sensor, thereby determining the state of the door of the respective passive fiber optic cabinet. In some embodiments, a signal delay line may be disposed between adjacent detection FBG sensors 211ₖ and 22ₖ₊₁ (k=1, 2, . . . , n−1) of the plurality of detection FBG sensors 211₁, 211₂, . . . , 211ₙ, so that a plurality of reflected lights reflected by the plurality of detection FBG sensors 211₁, 211₂, . . . , 211ₙ on one optical fiber 240₁ are distinguishable in terms of time. In such a case, the dispersing unit 231 may also be optionally omitted.

Next, the determination of the state of the door of each passive fiber optic cabinet by the processing unit 233 based on the wavelength of the reflected light is described by taking an embodiment in which the wavelength of the light reflected by the detection FBG sensor 211ᵢ (i=1, 2, . . . , n) is within the i-th wavelength range and the respective i-th wavelength ranges (i=1, 2, . . . , n) do not overlap each other, as an example. It is assumed that each detection FBG sensor 211ᵢ (i=1,2, . . . , n) reflects a wavelength λᵢ when the door is in the closed state and reflects a wavelength λᵢ′ when the door is in the open state, where λᵢ and λᵢ′ are within the i-th wavelength range. The light source module 220 may be configured to provide light including the 1st wavelength range to the nth wavelength range to the plurality of detection FBG sensors 211₁, 211₂, . . . , 211ₙ via the optical fiber 240₁. For example, when the processing unit 233 determines that the wavelengths of the plurality of reflected lights respectively include λ₁, λ₂, . . . , λᵢ, . . . , λₙ, it may be determined that the doors corresponding to the plurality of detection FBG sensors 211₁, 211₂, . . . , 211ₙ are all in the closed state; when the processing unit 233 determines that the wavelengths of the plurality of reflected lights respectively include λ₁, λ₂, . . . , λᵢ′, . . . , λₙ, it can be determined that the door corresponding to the detection FBG sensor 211ᵢ is in the open state and the doors corresponding to the other detection FBG sensors are in the closed state. Since each detection FBG sensor can correspond to a different passive fiber optic cabinet and its reflected wavelength is in a different range, it is possible to quickly know the reflected light is from a detection FBG sensor at which passive fiber optic cabinet by determining in which range the wavelength of the reflected light falls.

The output wavelength range of the light source module 220 may be pre-divided into a plurality of wavelength ranges and the plurality of wavelength range are assigned to a plurality of detection FBG sensors, and then the detection FBG sensors may be designed according to the respective wavelength ranges. The width of the wavelength range assigned to each FBG sensor may depend on a range of stresses to which the FBG sensor is subjected and/or a temperature range at which it is exposed, such that the wavelength reflected by the FBG sensor is always within the assigned wavelength range. The wavelength ranges assigned to the different FBG sensors do not overlap each other. Therefore, in some embodiments, an output wavelength range of the light source module 220 may be divided into a plurality of wavelength ranges to be assigned to the plurality of detection FBG sensors 211₁, 211₂, . . . , 211ₙ, a detection wavelength associated with each detection FBG sensor 211ᵢ being within a wavelength range assigned to the detection FBG sensor 211ᵢ, the analysis module 230 may be configured to determine, based on a wavelength range in which the determined wavelength of the reflected light is, a passive fiber optic cabinet of the plurality of passive fiber optic cabinets having a detection FBG sensor corresponding to the wavelength range

In this case, if the analysis module 230 determines that no signal is detected in at least one of the assigned wavelength ranges (i.e., none of wavelengths of the reflected lights falls in that wavelength range), it shows that an abnormality may occur in the detection FBG sensor corresponding to the at least one of the assigned wavelength ranges, a stress range and/or a temperature range to which the detection FBG sensor is subjected may exceed a normal range (e.g., abnormalities such as the passive fiber optic cabinet being on fire, being hit, and the like), at this time the system may be configured to issue an alarm in response to no signal being detected in at least one of the assigned wavelength ranges so as to alert related personnel to check. Therefore, in some embodiments, the system may further comprise an alarm module (not shown) which may be configured to issue an alarm in response to the analysis module 230 determining that there is a wavelength range, among the plurality of wavelength ranges, that none of wavelengths of the received reflected lights falls therein. The alarm may indicate that an abnormality may occur in the passive fiber optic cabinet where the detection FBG sensor corresponding to the wavelength range that none of wavelengths of the received reflected lights falls therein is present. In some examples, if the analysis module 230 determines that reflected light is received in wavelength range(s) corresponding to detection FBG sensor(s) positioned before some detection FBG sensor on an optical fiber but no reflected light is received in wavelength ranges corresponding to that detection FBG sensor and detection FBG sensor(s) positioned after that detection FBG sensor on the optical fiber, the alarm may indicate that the optical fiber may be disconnected near that detection FBG sensor. In some examples, if the analysis module 230 determines no reflected light is received in a wavelength range corresponding to some detection FBG sensor on an optical fiber but reflected light is received in wavelength range(s) corresponding to detection FBG sensor(s) positioned after that detection FBG sensor on the optical fiber, the alarm may indicate that an abnormality may occur in the passive fiber optic cabinet where that detection FBG sensor is present.

Therefore, the system 200′ can connect a plurality of detection FBG sensors corresponding to different detection wavelengths on one long-distance optical fiber, and can detect the states of the doors of a plurality of passive fiber optic cabinets at the same time.

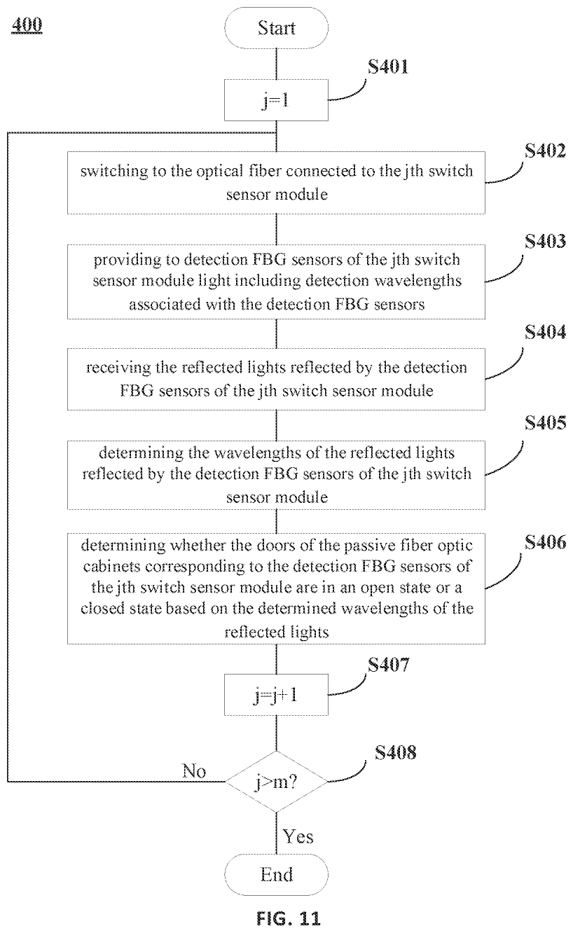

An example operation process of the system for detecting a state of a door of a passive fiber optic cabinet, comprising a plurality of switch sensor modules (e.g., as shown in FIG. 7) is described below in conjunction with FIG. 11. FIG. 11 is a flowchart illustrating an example method 400 for detecting a state of a door of a passive fiber optic cabinet according to some embodiments of the present disclosure. Referring to FIG. 7, the method 400 comprises: at step S401, selecting a first switch sensor module 210₁ (j=1); at step S402, the optical switch 260 being switched to the optical fiber 240₁ connected to the first switch sensor module 210₁; and at step S403, the light source module 220 providing to the detection FBG sensors 211₁, 211₂, . . . , 211ₙ of the first switch sensor module 210₁ light including detection wavelengths associated with the detection FBG sensors 211₁, 211₂, . . . , 211ₙ. The method 400 further comprises: at step S404, the analysis module 230 receiving the reflected lights reflected by the detection FBG sensors 211₁, 211₂, . . . , 211ₙ of the first switch sensor module 210₁; at step S405, the analysis module 230 determining the wavelengths of the reflected lights reflected by the detection FBG sensors 211₁, 211₂, . . . , 211ₙ of the first switch sensor module 210₁; and at step S406, the analysis module 230 determining whether doors of passive fiber optic cabinets corresponding to the detection FBG sensors 211₁, 211₂, . . . , 211ₙ of the first switch sensor module 210₁ are in an open state or a closed state based on the determined wavelengths of the reflected lights. Next, at step S407, the second switch sensor module 210₂ (j=2) is selected and then the steps S402 to S406 are repeated to determine whether doors of passive fiber optic cabinets corresponding to the detection FBG sensors of the second switch sensor module 210₂ are in an open state or a closed state. Next, a next switch sensor module (j=j+1) is selected and then the steps S402 to S406 are repeated to determine whether doors of passive fiber optic cabinets corresponding to the detection FBG sensors of that switch sensor module are in an open state or a closed state, until it is determined at step S408 that the detection of the mth switch sensor module 210ₘ has been completed (i.e., it is determined that the current j is greater than m).

It should be understood that while the method 400 illustrates providing light including the detection wavelengths to a respective switch sensor module and determining the wavelengths of the reflected lights to determine the states of the doors of the respective passive fiber optic cabinets in sequence from the first switch sensor module 210₁ to the mth switch sensor module 210ₘ, this is merely an example and the present disclosure is not limited thereto, and the system according to the embodiments of the present disclosure may perform detection of the switch sensor modules starting from any switch sensor module in any order up to traversing all switch sensor modules in the system, according to actual needs. Of course, it will also be understood that the system may select one or more of the switch sensor modules in the system to perform the detection in any suitable order according to actual needs, without traversing all switch sensor modules in the system. In some embodiments, the system may set different detection periods for different switch sensor modules. For example, detection periods for switch sensor modules corresponding to passive fiber optic cabinets as OSP may be set shorter than detection periods for switch sensor modules corresponding to passive fiber optic cabinets as ISPF. In some embodiments, the system may provide light to one or more of the plurality of switch sensor modules continuously for continuous detection. In this way, the passive fiber optic cabinet(s) with important resources deployed therein or the passive fiber optic cabinet(s) with a high probability to be opened, etc., can be more closely monitored, thereby optimizing the resource configuration.

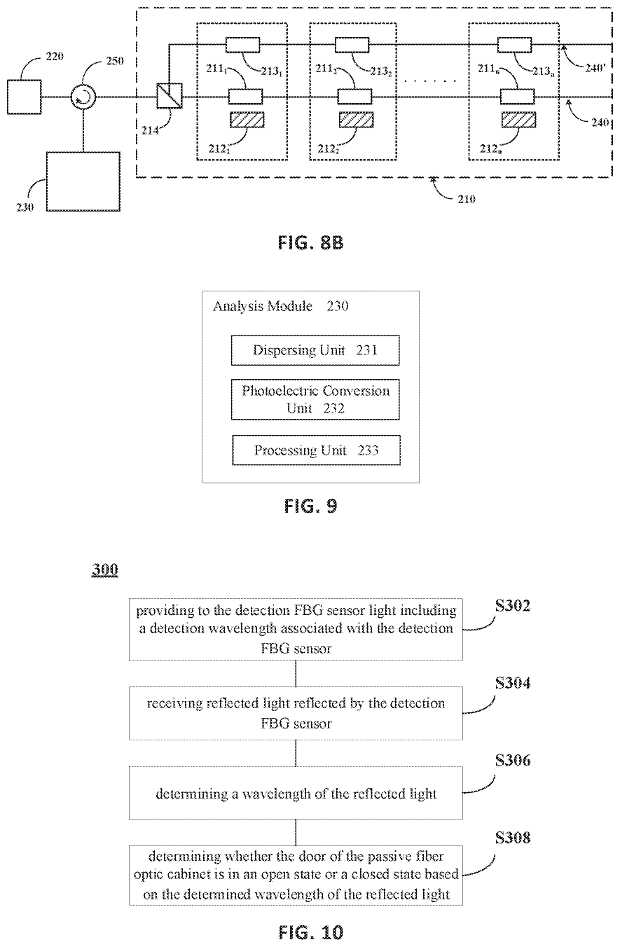

A configuration in which the reference FBG sensors are provided in case where the switch sensor module 210 may include a plurality of detection FBG sensors 211₁, 211₂, . . . , 211ₙ and a plurality of stress applying mechanisms 212₁, 212₂, . . . , 212ₙ is described below in conjunction with FIGS. 8A and 8B. In FIGS. 8A and 8B, dotted boxes indicate the passive fiber optic cabinets and a dashed box indicates the switch sensor module.

In some embodiments, the switch sensor module 210 may further include a plurality of reference FBG sensors 213₁, 213₂, . . . , 213ₙ corresponding to the plurality of detection FBG sensors 211₁, 211₂, . . . , 211n, each reference FBG sensor 213ᵢ (i=1, 2, . . . , n) being positioned at a respective one of the passive fiber optic cabinets at a position at which a temperature is substantially the same as a temperature at the position of the detection FBG sensor 211ᵢ (i=1, 2, . . . , n) but no stress is applied to the reference FBG sensor 213ᵢ (i=1, 2, . . . , n) by the stress applying mechanism 212ᵢ (i=1,2, . . . , n). In some embodiments, the plurality of reference FBG sensors 213₁, 213₂, . . . , 213ₙ are disposed in an optical fiber, the light source module 220 is further configured to provide light having reference wavelengths associated with the respective reference FBG sensors 213₁, 213₂, . . . , 213ₙ to the plurality of reference FBG sensors 213₁, 213₂, . . . , 213ₙ via the optical fiber, and the reference wavelengths associated with the respective reference FBG sensors 213₁, 213₂, . . . , 213ₙ are different from each other.

In some embodiments, the plurality of reference FBG sensors 213₁, 213₂, . . . , 213ₙ and the plurality of detection FBG sensors 211₁, 211₂, . . . , 211ₙ are disposed in the same optical fiber, and the reference wavelengths associated with the respective reference FBG sensors 213₁, 213₂, . . . , 213ₙ are different from the detection wavelengths associated with the respective detection FBG sensors 211₁, 211₂, . . . , 211ₙ.

In some embodiments, for example with reference to FIG. 8A, the system comprises a plurality of beam splitters 214₁, 214₂, . . . , 214ₙ corresponding to the plurality of detection FBG sensors 211₁, 211₂, . . . , 211ₙ, each beam splitter being configured to branch off at least one branch fiber from the optical fiber where the corresponding detection FBG sensor is disposed, the respective reference FBG sensors 213₁, 213₂, . . . , 213ₙ being provided in the branch fibers branched off by the respective beam splitters 214₁, 214₂, . . . , 214ₙ, respectively, and the reference wavelengths associated with the respective reference FBG sensors 213₁, 213₂, . . . , 213ₙ being different from the detection wavelengths associated with the respective detection FBG sensors 211₁, 211₂, . . . , 211ₙ. Further, as discussed above, in some embodiments, when a time delay means such as a signal delay line is disposed in an optical path between each reference FBG sensor 213₁, 213₂, . . . , 213ₙ and the corresponding beam splitter 214₁, 214₂, . . . , 214ₙ, the reference wavelength associated with each reference FBG sensor 213ᵢ (i=1, 2, . . . , n) may be the same as the detection wavelength associated with the corresponding detection FBG sensor 211ᵢ (i=1, 2, . . . , n) (the detection wavelengths associated with the respective detection FBG sensors 211₁, 211₂, . . . , 211ₙ are different from each other, and the reference wavelengths associated with the respective reference FBG sensors 213₁, 213₂, . . . , 213ₙ are different from each other). In this case, although the reflected lights from the detection FBG sensor 211ᵢ (i=1, 2, . . . , n) and the reference FBG sensor 213ᵢ (i=1, 2, . . . , n) are not distinguishable in terms of their wavelengths, they are distinguishable in terms of time.

In some embodiments, for example referring to FIG. 8B, the system comprises a beam splitter 214 configured to branch off at least one branch fiber from the optical fiber where the detection FBG sensors are disposed, and a plurality of reference FBG sensors 213₁, 213₂, . . . , 213ₙ may be provided in one or more of the at least one branch fibers. In the non-limiting example shown in FIG. 8B, the plurality of reference FBG sensors 213₁, 213₂, . . . , 213ₙ are disposed in the same branch fiber 240′, wherein the reference wavelengths associated with the respective reference FBG sensor 213₁, 213₂, . . . , 213ₙ are different from the detection wavelengths associated with the respective detection FBG sensor 211₁, 211₂, . . . , 211ₙ. Further, as discussed above, in some embodiments, when a time delay means such as a signal delay line is disposed in an optical path between the reference FBG sensor 213₁ and the beam splitter 214, the reference wavelength associated with each reference FBG sensor 213ᵢ (i=1, 2, . . . , n) may be the same as the detection wavelength associated with the corresponding detection FBG sensor 211ᵢ (i=1, 2, . . . , n), but the detection wavelengths associated with the respective detection FBG sensors 211₁, 211₂, . . . , 211ₙ are different from each other, and the reference wavelengths associated with the respective reference FBG sensors 213₁, 213₂, . . . , 213ₙ are different from each other.

In some embodiments, a wavelength of the light reflected by the detection FBG sensor 211ᵢ (i=1,2, . . . , n) is within an i-th wavelength range, a wavelength of the light reflected by the reference FBG sensor 213ⱼ (j=n+1, n+2, . . . , 2n) is within a j-th wavelength range, and the 1st wavelength range to the 2n-th wavelength range do not overlap with each other.

In some embodiments, the output wavelength range of the light source module 220 may be pre-divided into a plurality of wavelength ranges and assigned to the plurality of detection FBG sensors and the plurality of reference FBG sensors, and then the detection FBG sensors and the reference FBG sensors may be designed according to the respective wavelength ranges. The width of the wavelength range assigned to each FBG sensor may depend on a range of stress to which the FBG sensor is subjected and/or a temperature range at which it is exposed, such that the wavelength reflected by the FBG sensor is always within the assigned wavelength range. The wavelength ranges assigned to different FBG sensors do not overlap each other. For example, when the output wavelength range of the light source module 220 is from 1530 nm to 1565 nm, a wavelength range of 1530 nm to 1536 nm may be assigned for detecting a state of a door of a first passive fiber optic cabinet, wherein a wavelength range of 1530 nm to 1533 nm is assigned to the detection FBG sensor 211₁, and a wavelength range of 1534 nm to 1536 nm is assigned to the reference FBG sensor 213₁; a wavelength range of 1537 nm to 1543 nm may be assigned for detecting a state of a door of a second passive fiber optic cabinet, wherein a wavelength range of 1537 nm to 1540 nm is assigned to the detection FBG sensor 211₂, and a wavelength range of 1541 nm to 1543 nm is assigned to the reference FBG sensor 213₂; and so on.

In some embodiments, when the optical fiber where the detection FBG sensor (and/or the reference FBG sensor, if provided) is disposed is an optical fiber for fiber optic communication of a passive fiber optic cabinet, the detection wavelength (and/or the reference wavelength, if a reference FBG sensor is provided) is outside an operating wavelength range for the fiber optic communication. In some embodiments, when the optical fiber where the detection FBG sensor (and/or the reference FBG sensor, if provided) is not an optical fiber for fiber optic communication of a passive fiber optic cabinet, the detection wavelength (and/or the reference wavelength, if a reference FBG sensor is provided) can be in any suitable wavelength range.

In some embodiments, the light source module 220 may be configured to output light having a first intensity for monitoring the state of the door of the passive fiber optic cabinet, and the light source module 220 may be further configured to, when the analysis module 230 determines that the door of the passive fiber optic cabinet is in the open state, output light having a second intensity higher than the first intensity for re-determining whether the door of the passive fiber optic cabinet is in the open state. In this way, energy saving can be facilitated.

A system for detecting a state of a door of a passive fiber optic cabinet according to embodiments of the present disclosure is described in detail below with reference to FIG. 13. FIG. 13 is an exemplary schematic diagram illustrating a system 500 for detecting a state of a door of a passive fiber optic cabinet according to some further embodiments of the present disclosure. It should be noted that other components may be present in an actual system for detecting a state of a door of a passive fiber optic cabinet, but are not shown in the figures and discussed herein in order to avoid obscuring the points of the present disclosure. In FIG. 13, dotted boxes indicate the passive fiber optic cabinets and a dashed box indicates the switch sensor module.

The system 500 also comprises a switch sensor module 510 having a detection FBG sensor (e.g., a detection FBG sensor 511₁, 511₂, . . . ) and a stress applying mechanism (e.g., a stress applying mechanism 512₁, 512₂, . . . ) corresponding to the detection FBG sensor, a light source module 520, and an analysis module 530. Light output by the light source module 520 reaches the switch sensor module 510 through an optical circulator 550, a portion of which reaches the analysis module 530 through the optical circulator 550 after being reflected by the detection FBG sensor in the switch sensor module 510. Each part of the system 500 may have the same or similar function and configuration as the same or similar part discussed above, and thus repeated descriptions are omitted here and attention is focused on the differences of the system 500.

The system 500 may comprise a trunk fiber 540, wherein the light source module 520 may be configured to provide light including the detection wavelength associated with the detection FBG sensor (e.g., the detection FBG sensor 511₁, 511₂, . . . ) of the switch sensor module 510 to the trunk fiber 540. The switch sensor module 510 may further comprise a beam splitter (e.g., a beam splitter 514₁, 514₂, . . . ) corresponding to the detection FBG sensor (e.g., the detection FBG sensor 511₁, 511₂, . . . ), the beam splitter configured to branch off a branch fiber (e.g., a branch fiber 540₁, 540₂, . . . ) from the trunk fiber 540, wherein the detection FBG sensor is disposed in the branch fiber.

It will be appreciated that, although not illustrated in FIG. 13, the switch sensor module 510 of the system 500 may also comprise a reference FBG sensor. For example, the reference FBG sensor may be disposed in the same branch fiber as the detection FBG sensor, or may be disposed in another branch fiber (different from the branch fiber where the detection FBG sensor is present) that is branched off from the trunk fiber by the beam splitter. The discussion regarding the configuration of the reference FBG sensor is similar as above and thus is not repeated here.

In some embodiments, as shown in FIG. 13, the switch sensor module 510 may include a plurality of detection FBG sensors 511₁, 511₂, . . . , a plurality of stress applying mechanisms 512₁, 512₂, . . . corresponding to the plurality of detection FBG sensors 511₁, 511₂, . . . , and a plurality of beam splitters 514₁, 514₂, . . . corresponding to the plurality of detection FBG sensors 511₁, 511₂, . . . , each of the detection FBG sensors and the corresponding stress applying mechanism and corresponding beam splitter being disposed at one of a plurality of passive fiber optic cabinets for detecting a state of a door of the one passive fiber optic cabinet, each of the detection FBG sensors being disposed in a branch fiber branched off from the trunk fiber 540 via the beam splitter corresponding to the detection FBG sensor.

In some embodiments, detection wavelengths associated with the respective detection FBG sensors of the plurality of detection FBG sensors 511₁, 511₂, . . . may be different from each other.

In some embodiments, the plurality of detection FBG sensors 511₁, 511₂, . . . include at least a first detection FBG sensor (e.g., the detection FBG sensor 511₁) and a second detection FBG sensor (e.g., the detection FBG sensor 511₂), the first detection FBG sensor 511₁ and the second detection FBG sensor 511₂ configured such that a detection wavelength associated with the first detection FBG sensor 511₁ is the same as a detection wavelength associated with the second detection FBG sensor 511₂, and a distance along the fiber from the first detection FBG sensor 511₁ to the analysis module 530 and a distance along the fiber from the second detection FBG sensor 511₂ to the analysis module 530 differ by at least a first threshold configured such that a time difference between when the reflected lights from the first detection FBG sensor 511₁ and the second detection FBG sensor 511₂ are received by the analysis module 530 is no less than a predetermined time threshold. The predetermined time threshold may be set as discussed above.

In such embodiments, the light source module 520 may be configured to provide a light pulse including detection wavelengths associated with the plurality of detection FBG sensors 511₁, 511₂, . . . to the trunk fiber 540, the analysis module 530 may be further configured to determine a passive fiber optic cabinet of the plurality of passive fiber optic cabinets that corresponds to the reflected light based on the determined wavelength of the reflected light and the time at which the reflected light is received.

Although the above describes that the detection wavelength associated with the first detection FBG sensor 511₁ is the same as the detection wavelength associated with the second detection FBG sensor 511₂, it will be appreciated that, the number of detection FBG sensors having the same detection wavelength among the plurality of detection FBG sensors 511₁, 511₂, . . . may be more than two, as long as distances along the fiber from any two adjacent detection FBG sensors of these detection FBG sensors to the analysis module 530 differ by at least the first threshold. It will also be appreciated that, when the output wavelength range of the light source is divided into a plurality of wavelength ranges and the plurality of wavelength ranges is assigned to the plurality of detection FBG sensors 511₁, 511₂, . . . , wavelength ranges associated with at least two of the plurality of detection FBG sensors 511₁, 511₂, . . . (e.g., the first detection FBG sensor 511₁ and the second detection FBG sensor 511₂) may at least partially overlap, as long as distances along the fiber from any two adjacent detection FBG sensors of the at least two detection FBG sensors to the analysis module 530 differ by at least the first threshold.

For example, in a case where the system 500 is used to monitor first to fifteenth passive fiber optic cabinets, when the output wavelength range of the light source module 520 is from 1530 nm to 1565 nm, wavelength ranges of 1530 nm to 1536 nm, 1537 nm to 1543 nm, 1544 nm to 1550 nm, 1551 nm to 1557 nm, 1558 nm to 1564 nm may be assigned for detecting the states of doors of the first to fifth passive fiber optic cabinets, respectively, the wavelength ranges of 1530 nm to 1536 nm, 1537 nm to 1543 nm, 1544 nm to 1550 nm, 1551 nm to 1557 nm, 1558 nm to 1564 nm may also be assigned for detecting the states of doors of the sixth to tenth passive fiber optic cabinets, respectively, and the wavelength ranges of 1530 nm to 1536 nm, 1537 nm to 1543 nm, 1544 nm to 1550 nm, 1551 nm to 1557 nm, 1558 nm to 1564 nm may further be assigned for detecting the states of doors of the eleventh to fifteenth passive fiber optic cabinets, respectively, as long as distances along the fiber from any two adjacent detection FBG sensors of the detection FBG sensors of the ith, (i+5)th, and (i+10)th passive fiber optic cabinets (i=1, 2, . . . , 5) to the analysis module 530 differ by at least the first threshold.

The passive fiber optic cabinet and the system for detecting the state of the door of the passive fiber optic cabinet according to the embodiments of the present disclosure, by employing the FBG sensors and the optical fibers, can detect the state of the door of the passive fiber optic cabinet accurately and reliably under a passive condition without being affected by electromagnetic induction noise, can perform long-distance detection with a very low data loss rate or even zero loss, and meanwhile, can perform the detection of a plurality of FBG sensors simultaneously in one optical fiber, which greatly reduces the size, weight, deployment cost and complexity of the detection system.

The terms “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the present disclosure described herein are, for example, capable of operating in other orientations than those illustrated or otherwise described herein.

As used herein, the term “exemplary” means “serving as an example, instance, or illustration,” and not a “model” that is to be reproduced exactly. Any implementation exemplarily described herein is not necessarily to be construed as preferred or advantageous over other implementations. Furthermore, the present disclosure is not restricted by any expressed or implied theory presented in the technical field, background, summary, or detailed description.

As used herein, the term “substantially” is intended to encompass any minor variations due to design or manufacturing imperfections, tolerances of the devices or components, environmental influences and/or other factors. The term “substantially” also allows for differences from a perfect or ideal situation due to parasitic effect, noise, and other practical considerations that may exist in a practical implementation.

In addition, the description herein may refer to elements or nodes or features being “connected” or “coupled” together. As used herein, unless expressly stated otherwise, “connected” means that one element/node/feature may be directly or indirectly connected to (or in communication with) another element/node/feature, either electrically, mechanically, logically, or otherwise. Similarly, unless expressly stated otherwise, “coupled” means that one element/node/feature may be joined to another element/node/feature in a direct or indirect manner, either mechanically, electrically, logically or otherwise to allow interaction, even though the two features may not be directly connected. That is, “connected” or “coupled” is intended to encompass both direct and indirect joining of elements or other features, including connection with one or more intermediate elements.

In addition, terms such as “first,” “second,” and the like may also be used herein for reference purposes only, and thus are not intended to be limiting. For example, the terms “first,” “second,” and other such numerical terms referring to structures or elements do not imply a sequence or order unless clearly indicated by the context.

It will be further understood that the terms “comprise/include” when used herein, specify the presence of stated features, entireties, steps, operations, units, and/or components, but do not preclude the presence or addition of one or more other features, entireties, steps, operations, units, components, and/or a combination thereof.

In the present disclosure, the term “providing” is used broadly to encompass all ways of obtaining an object, and thus “providing an object” includes, but is not limited to, “purchasing,” “preparing/manufacturing,” “arranging/setting,” “installing/assembling,” and/or “ordering” an object, and the like.

As used herein, the term “and/or” includes any and all combinations of one or more of the associated listed items. The term used herein is for the purpose of describing particular embodiments only and is not intended to be limiting. As used herein, the singular forms “a”, “an” and “the” are intended to include the plural forms as well, unless the context clearly indicates otherwise.

Those skilled in the art will appreciate that the boundaries between the above described operations are merely illustrative. Multiple operations may be combined into a single operation, a single operation may be distributed in additional operations, and operations may be performed at least partially overlapping in time. Moreover, alternative embodiments may include multiple instances of a particular operation, and the order of operations may be altered in various other embodiments. However, other modifications, variations, and alternatives are also possible. The aspects and elements of all embodiments disclosed above may be combined in any manner and/or in combination with aspects or elements of the other embodiments to provide multiple additional embodiments. The specification and drawings are, accordingly, to be regarded in an illustrative rather than a restrictive sense.

The present disclosure may further include the following examples:
1. A passive fiber optic cabinet, comprising:
a housing;
a door coupled to the housing and configured to be switchable between an open state and a closed state;
a switch sensor module including a detection fiber Bragg grating (FBG) sensor and a stress applying mechanism corresponding to the detection FBG sensor, the stress applying mechanism configured to apply a stress to the detection FBG sensor, one of the detection FBG sensor and the stress applying mechanism being positioned at the door, and the other of the detection FBG sensor and the stress applying mechanism being positioned at the housing.
2. The passive fiber optic cabinet according to example 1, wherein the stress applied to the detection FBG sensor by the stress applying mechanism is greater when the door is in the closed state than when the door is in the open state.
3. The passive fiber optic cabinet according to example 1, wherein the detection FBG sensor is disposed in an optical fiber and is configured to receive light including a detection wavelength associated with the detection FBG sensor, from an external light source via the optical fiber.
4. The passive fiber optic cabinet according to example 3, wherein the switch sensor module further includes a reference FBG sensor corresponding to the detection FBG sensor, the reference FBG sensor being positioned at the passive fiber optic cabinet at a position at which a temperature is substantially the same as a temperature at the position of the detection FBG sensor but no stress is applied to the reference FBG sensor by the stress applying mechanism.
5. The passive fiber optic cabinet according to example 4, wherein the reference FBG sensor is disposed in an optical fiber and is configured to receive light including a reference wavelength associated with the reference FBG sensor, from an external light source via the optical fiber.
6. The passive fiber optic cabinet according to example 5, wherein the reference FBG sensor and the detection FBG sensor are disposed in the same optical fiber, and wherein the reference wavelength is different from the detection wavelength.
7. The passive fiber optic cabinet according to example 5, further comprising:
a beam splitter configured to branch off at least one branch fiber from the optical fiber where the detection FBG sensor is disposed,
wherein the reference FBG sensor is disposed in one of the at least one branch fiber, and wherein the reference wavelength is different from the detection wavelength.
8. The passive fiber optic cabinet according to example 3, wherein the detection wavelength depends on a refractive index of a core of the optical fiber where the detection FBG sensor is disposed and a grating period of the detection FBG sensor.
9. The passive fiber optic cabinet according to example 1, wherein the stress applying mechanism comprises a magnet.
10. The passive fiber optic cabinet according to example 3, wherein the detection wavelength is in a range from 1530 nm to 1565 nm.
11. The passive fiber optic cabinet according to example 3, wherein when the optical fiber where the detection FBG sensor is disposed is an optical fiber for fiber optic communication, the detection wavelength is outside an operating wavelength range for the fiber optic communication.
12. A system for detecting a state of a door of a passive fiber optic cabinet, comprising:
a switch sensor module including a detection FBG sensor and a stress applying mechanism corresponding to the detection FBG sensor, the stress applying mechanism configured to apply a stress to the detection FBG sensor, one of the detection FBG sensor and the stress applying mechanism being positioned at the door of the passive fiber optic cabinet, and the other of the detection FBG sensor and the stress applying mechanism being positioned at a housing of the passive fiber optic cabinet;
a light source module configured to provide light including a detection wavelength associated with the detection FBG sensor to the detection FBG sensor; and
an analysis module configured to
receive reflected light reflected by the detection FBG sensor,
determine a wavelength of the reflected light, and
determine whether the door of the passive fiber optic cabinet is in an open state or a closed state based on the determined wavelength of the reflected light.
13. The system according to example 12, wherein the stress applied to the detection FBG sensor by the stress applying mechanism is greater when the door of the passive fiber optic cabinet is in the closed state than when the door of the passive fiber optic cabinet is in the open state.
14. The system according to example 12, wherein the detection FBG sensor is disposed in an optical fiber, and the light source module is configured to provide light to the detection FBG sensor via the optical fiber.
15. The system according to example 14, wherein the system comprises a plurality of switch sensor modules, wherein the detection FBG sensor of each of the switch sensor modules is disposed in a respective one of a plurality of optical fibers, and wherein the light source module is configured to provide light to the detection FBG sensor of one of the plurality of switch sensor modules via the respective optical fiber, respectively, through an optical switch.
16. The system according to example 14, wherein the switch sensor module includes a plurality of detection FBG sensors and a plurality of stress applying mechanisms corresponding to the plurality of detection FBG sensors, each of the detection FBG sensors and the corresponding stress applying mechanism being disposed at one of a plurality of passive fiber optic cabinets for detecting a state of a door of the one passive fiber optic cabinet, the plurality of detection FBG sensors being disposed in a same optical fiber, and detection wavelengths associated with the respective detection FBG sensors being different from each other.
17. The system according to example 14, wherein the switch sensor module further includes a reference FBG sensor corresponding to the detection FBG sensor, the reference FBG sensor being positioned at the passive fiber optic cabinet at a position at which a temperature is substantially the same as a temperature at the position of the detection FBG sensor but no stress is applied to the reference FBG sensor by the stress applying mechanism, and the light source module is further configured to provide light including a reference wavelength associated with the reference FBG sensor to the reference FBG sensor.
18. The system according to example 17, wherein the reference FBG sensor and the detection FBG sensor are disposed in the same optical fiber, and the reference wavelength is different from the detection wavelength.
19. The system according to example 17, further comprising:
a beam splitter configured to branch off at least one branch fiber from the optical fiber where the detection FBG sensor is disposed,
wherein the reference FBG sensor is disposed in one of the at least one branch fiber, and wherein the reference wavelength is different from the detection wavelength.
20. The system according to example 14, wherein the detection wavelength depends on a refractive index of a core of the optical fiber where the detection FBG sensor is disposed and a grating period of the detection FBG sensor.
21. The system according to example 12, wherein the analysis module comprises a photoelectric conversion unit configured to convert the reflected light reflected by the detection FBG sensor into an electrical signal, and a processing unit configured to determine a wavelength of the reflected light based on the electrical signal from the photoelectric conversion unit.
22. The system according to example 21, wherein the processing unit is further configured to compare the determined wavelength of the reflected light with the detection wavelength to determine whether the door of the passive fiber optic cabinet is in the open state or the closed state.
23. The system according to example 21, wherein the processing unit is further configured to determine whether the door of the passive fiber optic cabinet is in the open state or the closed state based on a variation of the determined wavelength of the reflected light over time.
24. The system according to example 16, wherein the analysis module includes a dispersing unit configured to receive a plurality of reflected lights reflected by the plurality of detection FBG sensors and spatially disperse the plurality of reflected lights depending on wavelengths, a photoelectric conversion unit configured to receive the plurality of reflected lights spatially dispersed by the dispersing unit and output an electrical signal corresponding to each of the plurality of reflected lights, and a processing unit configured to determine a wavelength of each of the plurality of reflected lights based on the electrical signal from the photoelectric conversion unit.
25. The system according to example 24, wherein the dispersing unit comprises a dispersive optical element selected from a group comprising a dispersive mirror, a prism, or a grating.
26. The system according to example 24, wherein the photoelectric conversion unit comprises an array of photoelectric conversion elements, and the plurality of reflected lights reach different photoelectric conversion elements in the array after passing through the dispersing unit.
27. The system according to example 16, wherein the analysis module includes a wavelength selective unit configured to receive a plurality of reflected lights reflected by the plurality of detection FBG sensors and selectively output one of the plurality of reflected lights, a photoelectric conversion unit configured to receive the one reflected light output by the wavelength selective unit and output an electrical signal corresponding to the one reflected light, and a processing unit configured to determine a wavelength of the one reflected light based on the electrical signal from the photoelectric conversion unit.
28. The system according to example 27, wherein the wavelength selective unit comprises one of: a Fabry-Perot filter, a liquid crystal tunable filter, an acoustic-optic tunable filter, a monochromator.
29. The system according to example 12, wherein the light source module comprises at least one of: a broadband light source, a tunable laser source, and a combination of a plurality of narrow-band light sources.
30. The system according to example 12, wherein the stress applying mechanism comprises a magnet.
31. The system according to example 12, wherein the light source module outputs light in a wavelength range from 1530 nm to 1565 nm.
32. The system according to example 14, wherein when the optical fiber where the detection FBG sensor is disposed is an optical fiber for fiber optic communication, a wavelength range for the detection FBG sensor to detect the state of the door does not overlap with an operating wavelength range for the fiber optic communication.
33. The system according to example 12, wherein the light source module is configured to output light having a first intensity for monitoring the state of the door of the passive fiber optic cabinet, and the light source module is further configured to, when the analysis module determines that the door of the passive fiber optic cabinet is in the open state, output light having a second intensity higher than the first intensity for re-determining whether the door of the passive fiber optic cabinet is in the open state.
34. The system according to example 12, wherein the light source module and the analysis module are remotely positioned relative to the passive fiber optic cabinet.
35. The system according to example 12, further comprising a trunk fiber, wherein
the light source module is configured to provide light including the detection wavelength associated with the detection FBG sensor to the trunk fiber, and
the switch sensor module further comprises a beam splitter corresponding to the detection FBG sensor, the beam splitter configured to branch off a branch fiber from the trunk fiber, wherein the detection FBG sensor is disposed in the branch fiber.
36. The system according to example 35, wherein the switch sensor module includes a plurality of detection FBG sensors, a plurality of stress applying mechanisms corresponding to the plurality of detection FBG sensors, and a plurality of beam splitters corresponding to the plurality of detection FBG sensors, each of the detection FBG sensors and the corresponding stress applying mechanism and corresponding beam splitter being disposed at one of a plurality of passive fiber optic cabinets for detecting a state of a door of the one passive fiber optic cabinet, each of the detection FBG sensors being disposed in a branch fiber branched off from the trunk fiber via the beam splitter corresponding to the detection FBG sensor.
37. The system according to example 36, wherein detection wavelengths associated with the respective detection FBG sensors of the plurality of detection FBG sensors are different from each other.
38. The system according to example 36, wherein the plurality of detection FBG sensors include at least a first detection FBG sensor and a second detection FBG sensor, the first and second detection FBG sensors configured such that a detection wavelength associated with the first detection FBG sensor is the same as a detection wavelength associated with the second detection FBG sensor, and a distance along the fiber from the first detection FBG sensor to the analysis module and a distance along the fiber from the second detection FBG sensor to the analysis module differ by at least a first threshold configured such that a time difference between when the reflected lights from the first and second detection FBG sensors are received by the analysis module is no less than a predetermined time threshold.
39. The system according to example 38, wherein the light source module is configured to provide a light pulse including detection wavelengths associated with the plurality of detection FBG sensors to the trunk fiber, the analysis module is further configured to determine a passive fiber optic cabinet of the plurality of passive fiber optic cabinets that corresponds to the reflected light based on the determined wavelength of the reflected light and the time at which the reflected light is received.
40. The system according to example 16, wherein an output wavelength range of the light source module is divided into a plurality of wavelength ranges to be assigned to the plurality of detection FBG sensors, a detection wavelength associated with each detection FBG sensor being within a wavelength range assigned to the detection FBG sensor, the analysis module is configured to determine, based on a wavelength range in which the determined wavelength of the reflected light is, a passive fiber optic cabinet of the plurality of passive fiber optic cabinets having a detection FBG sensor corresponding to the wavelength range.
41. The system according to example 40, wherein the system further comprises an alarm module configured to issue an alarm in response to the analysis module determining that there is a wavelength range, among the plurality of wavelength ranges, that none of wavelengths of the received reflected lights falls therein.
42. A system for detecting a state of a door of a passive fiber optic cabinet, comprising:
a plurality of passive fiber optic cabinets, each being the passive fiber optic cabinet according to any of examples 1-11;
a light source module configured to provide light including detection wavelengths associated with the detection FBG sensors to the detection FBG sensors; and
an analysis module configured to
receive reflected lights reflected by the detection FBG sensors,
determine wavelengths of the reflected lights, and
determine whether the doors of the passive fiber optic cabinets are in an open state or a closed state based on the determined wavelengths of the reflected lights.
43. The system according to example 42, wherein the detection FBG sensors of the plurality of passive fiber optic cabinets are disposed in a same optical fiber, and the detection wavelengths associated with the respective detection FBG sensors are different from each other.
44. The system according to example 42, wherein the plurality of passive fiber optic cabinets comprises a first group of passive fiber optic cabinets and a second group of passive fiber optic cabinets, the detection FBG sensors of each of the first group of passive fiber optic cabinets are disposed in a first optical fiber, and the detection wavelengths associated with the respective detection FBG sensors of the first group of passive fiber optic cabinets are different from each other, the detection FBG sensors of each of the second group of passive fiber optic cabinets are disposed in a second optical fiber different from the first optical fiber, and the detection wavelengths associated with the respective detection FBG sensors of the second group of passive fiber optic cabinets are different from each other.
45. The system according to example 44, wherein the detection wavelengths associated with the respective detection FBG sensors of the first group of passive fiber optic cabinets and the detection wavelengths associated with the respective detection FBG sensors of the second group of passive fiber optic cabinets have at least one same detection wavelength.
46. The system according to example 45, wherein the light source module is configured to provide light to the respective detection FBG sensors of the first group of passive fiber optic cabinets and the respective detection FBG sensors of the second group of passive fiber optic cabinets via the first and second optical fibers, respectively, through an optical switch.
47. The system according to example 45, wherein the detection FBG sensors of the first group of passive fiber optic cabinets include at least a first detection FBG sensor, the detection FBG sensors of the second group of passive fiber optic cabinets include at least a second detection FBG sensor, the first and second detection FBG sensors configured such that a detection wavelength associated with the first detection FBG sensor is the same as a detection wavelength associated with the second detection FBG sensor, and a distance along the fiber from the first detection FBG sensor to the analysis module and a distance along the fiber from the second detection FBG sensor to the analysis module differ by at least a first threshold configured such that a time difference between when the reflected lights from the first and second detection FBG sensors are received by the analysis module is no less than a predetermined time threshold.
48. The system according to example 42, wherein the analysis module is configured to determine whether the doors of the passive fiber optic cabinets are in the open state or the closed state based on variations of the determined wavelengths of the reflected lights over time.

Although some specific embodiments of the present disclosure have been described in detail by way of example, it should be understood by those skilled in the art that the above examples are for illustration only and are not intended to limit the scope of the present disclosure. The various embodiments disclosed herein may be combined in any manner without departing from the spirit and scope of the present disclosure. Those skilled in the art will also appreciate that various modifications might be made to the embodiments without departing from the scope and spirit of the present disclosure. The scope of the present disclosure is defined by the attached claims.

1. A passive fiber optic cabinet, comprising:
a housing;
a door coupled to the housing and configured to be switchable between an open state and a closed state;
a switch sensor module including a detection fiber Bragg grating (FBG) sensor and a stress applying mechanism corresponding to the detection FBG sensor, the stress applying mechanism configured to apply a stress to the detection FBG sensor, one of the detection FBG sensor and the stress applying mechanism being positioned at the door, and the other of the detection FBG sensor and the stress applying mechanism being positioned at the housing.

2. The passive fiber optic cabinet according to claim 1, wherein the stress applied to the detection FBG sensor by the stress applying mechanism is greater when the door is in the closed state than when the door is in the open state.

3. The passive fiber optic cabinet according to claim 1, wherein the detection FBG sensor is disposed in an optical fiber and is configured to receive light including a detection wavelength associated with the detection FBG sensor, from an external light source via the optical fiber.

4. The passive fiber optic cabinet according to claim 3, wherein the switch sensor module further includes a reference FBG sensor corresponding to the detection FBG sensor, the reference FBG sensor being positioned at the passive fiber optic cabinet at a position at which a temperature is substantially the same as a temperature at the position of the detection FBG sensor but no stress is applied to the reference FBG sensor by the stress applying mechanism.

5. The passive fiber optic cabinet according to claim 4, wherein the reference FBG sensor is disposed in an optical fiber and is configured to receive light including a reference wavelength associated with the reference FBG sensor, from an external light source via the optical fiber.

6. The passive fiber optic cabinet according to claim 5, wherein the reference FBG sensor and the detection FBG sensor are disposed in the same optical fiber, and wherein the reference wavelength is different from the detection wavelength.

7. The passive fiber optic cabinet according to claim 5, further comprising:
a beam splitter configured to branch off at least one branch fiber from the optical fiber where the detection FBG sensor is disposed,
wherein the reference FBG sensor is disposed in one of the at least one branch fiber, and wherein the reference wavelength is different from the detection wavelength.

8. The passive fiber optic cabinet according to claim 3, wherein the detection wavelength depends on a refractive index of a core of the optical fiber where the detection FBG sensor is disposed and a grating period of the detection FBG sensor.

9. The passive fiber optic cabinet according to claim 1, wherein the stress applying mechanism comprises a magnet.

10. The passive fiber optic cabinet according to claim 3, wherein the detection wavelength is in a range from 1530 nm to 1565 nm.

11. The passive fiber optic cabinet according to claim 3, wherein when the optical fiber where the detection FBG sensor is disposed is an optical fiber for fiber optic communication, the detection wavelength is outside an operating wavelength range for the fiber optic communication.

12. A system for detecting a state of a door of a passive fiber optic cabinet, comprising:
a switch sensor module including a detection FBG sensor and a stress applying mechanism corresponding to the detection FBG sensor, the stress applying mechanism configured to apply a stress to the detection FBG sensor, one of the detection FBG sensor and the stress applying mechanism being positioned at the door of the passive fiber optic cabinet, and the other of the detection FBG sensor and the stress applying mechanism being positioned at a housing of the passive fiber optic cabinet;
a light source module configured to provide light including a detection wavelength associated with the detection FBG sensor to the detection FBG sensor; and
an analysis module configured to
receive reflected light reflected by the detection FBG sensor,
determine a wavelength of the reflected light, and
determine whether the door of the passive fiber optic cabinet is in an open state or a closed state based on the determined wavelength of the reflected light.

13. The system according to claim 12, wherein the stress applied to the detection FBG sensor by the stress applying mechanism is greater when the door of the passive fiber optic cabinet is in the closed state than when the door of the passive fiber optic cabinet is in the open state.

14. The system according to claim 12, wherein the detection FBG sensor is disposed in an optical fiber, and the light source module is configured to provide light to the detection FBG sensor via the optical fiber.

15. The system according to claim 14, wherein the system comprises a plurality of switch sensor modules, wherein the detection FBG sensor of each of the switch sensor modules is disposed in a respective one of a plurality of optical fibers, and wherein the light source module is configured to provide light to the detection FBG sensor of one of the plurality of switch sensor modules via the respective optical fiber, respectively, through an optical switch.

16. The system according to claim 14, wherein the switch sensor module includes a plurality of detection FBG sensors and a plurality of stress applying mechanisms corresponding to the plurality of detection FBG sensors, each of the detection FBG sensors and the corresponding stress applying mechanism being disposed at one of a plurality of passive fiber optic cabinets for detecting a state of a door of the one passive fiber optic cabinet, the plurality of detection FBG sensors being disposed in a same optical fiber, and detection wavelengths associated with the respective detection FBG sensors being different from each other.

17. The system according to claim 14, wherein the switch sensor module further includes a reference FBG sensor corresponding to the detection FBG sensor, the reference FBG sensor being positioned at the passive fiber optic cabinet at a position at which a temperature is substantially the same as a temperature at the position of the detection FBG sensor but no stress is applied to the reference FBG sensor by the stress applying mechanism, and the light source module is further configured to provide light including a reference wavelength associated with the reference FBG sensor to the reference FBG sensor.

18. The system according to claim 17, wherein the reference FBG sensor and the detection FBG sensor are disposed in the same optical fiber, and the reference wavelength is different from the detection wavelength.

19. The system according to claim 17, further comprising:
a beam splitter configured to branch off at least one branch fiber from the optical fiber where the detection FBG sensor is disposed,
wherein the reference FBG sensor is disposed in one of the at least one branch fiber, and wherein the reference wavelength is different from the detection wavelength.

20. The system according to claim 14, wherein the detection wavelength depends on a refractive index of a core of the optical fiber where the detection FBG sensor is disposed and a grating period of the detection FBG sensor.

21. The system according to claim 12, wherein the analysis module comprises a photoelectric conversion unit configured to convert the reflected light reflected by the detection FBG sensor into an electrical signal, and a processing unit configured to determine a wavelength of the reflected light based on the electrical signal from the photoelectric conversion unit.

22. The system according to claim 21, wherein the processing unit is further configured to compare the determined wavelength of the reflected light with the detection wavelength to determine whether the door of the passive fiber optic cabinet is in the open state or the closed state.

23. The system according to claim 21, wherein the processing unit is further configured to determine whether the door of the passive fiber optic cabinet is in the open state or the closed state based on a variation of the determined wavelength of the reflected light over time.

24. The system according to claim 16, wherein the analysis module includes a dispersing unit configured to receive a plurality of reflected lights reflected by the plurality of detection FBG sensors and spatially disperse the plurality of reflected lights depending on wavelengths, a photoelectric conversion unit configured to receive the plurality of reflected lights spatially dispersed by the dispersing unit and output an electrical signal corresponding to each of the plurality of reflected lights, and a processing unit configured to determine a wavelength of each of the plurality of reflected lights based on the electrical signal from the photoelectric conversion unit.

25. The system according to claim 24, wherein the dispersing unit comprises a dispersive optical element selected from a group comprising a dispersive mirror, a prism, or a grating.

26. The system according to claim 24, wherein the photoelectric conversion unit comprises an array of photoelectric conversion elements, and the plurality of reflected lights reach different photoelectric conversion elements in the array after passing through the dispersing unit.

27. The system according to claim 16, wherein the analysis module includes a wavelength selective unit configured to receive a plurality of reflected lights reflected by the plurality of detection FBG sensors and selectively output one of the plurality of reflected lights, a photoelectric conversion unit configured to receive the one reflected light output by the wavelength selective unit and output an electrical signal corresponding to the one reflected light, and a processing unit configured to determine a wavelength of the one reflected light based on the electrical signal from the photoelectric conversion unit.

28. The system according to claim 27, wherein the wavelength selective unit comprises one of: a Fabry-Perot filter, a liquid crystal tunable filter, an acoustic-optic tunable filter, a monochromator.

29. The system according to claim 12, wherein the light source module comprises at least one of: a broadband light source, a tunable laser source, and a combination of a plurality of narrow-band light sources.

30. The system according to claim 12, wherein the stress applying mechanism comprises a magnet.

31. The system according to claim 12, wherein the light source module outputs light in a wavelength range from 1530 nm to 1565 nm.

32. The system according to claim 14, wherein when the optical fiber where the detection FBG sensor is disposed is an optical fiber for fiber optic communication, a wavelength range for the detection FBG sensor to detect the state of the door does not overlap with an operating wavelength range for the fiber optic communication.

33. The system according to claim 12, wherein the light source module is configured to output light having a first intensity for monitoring the state of the door of the passive fiber optic cabinet, and the light source module is further configured to, when the analysis module determines that the door of the passive fiber optic cabinet is in the open state, output light having a second intensity higher than the first intensity for re-determining whether the door of the passive fiber optic cabinet is in the open state.

34. The system according to claim 12, wherein the light source module and the analysis module are remotely positioned relative to the passive fiber optic cabinet.

35. The system according to claim 12, further comprising a trunk fiber, wherein
the light source module is configured to provide light including the detection wavelength associated with the detection FBG sensor to the trunk fiber, and
the switch sensor module further comprises a beam splitter corresponding to the detection FBG sensor, the beam splitter configured to branch off a branch fiber from the trunk fiber, wherein the detection FBG sensor is disposed in the branch fiber.

36. The system according to claim 35, wherein the switch sensor module includes a plurality of detection FBG sensors, a plurality of stress applying mechanisms corresponding to the plurality of detection FBG sensors, and a plurality of beam splitters corresponding to the plurality of detection FBG sensors, each of the detection FBG sensors and the corresponding stress applying mechanism and corresponding beam splitter being disposed at one of a plurality of passive fiber optic cabinets for detecting a state of a door of the one passive fiber optic cabinet, each of the detection FBG sensors being disposed in a branch fiber branched off from the trunk fiber via the beam splitter corresponding to the detection FBG sensor.

37. The system according to claim 36, wherein detection wavelengths associated with the respective detection FBG sensors of the plurality of detection FBG sensors are different from each other.

38. The system according to claim 36, wherein the plurality of detection FBG sensors include at least a first detection FBG sensor and a second detection FBG sensor, the first and second detection FBG sensors configured such that a detection wavelength associated with the first detection FBG sensor is the same as a detection wavelength associated with the second detection FBG sensor, and a distance along the fiber from the first detection FBG sensor to the analysis module and a distance along the fiber from the second detection FBG sensor to the analysis module differ by at least a first threshold configured such that a time difference between when the reflected lights from the first and second detection FBG sensors are received by the analysis module is no less than a predetermined time threshold.

39. The system according to claim 38, wherein the light source module is configured to provide a light pulse including detection wavelengths associated with the plurality of detection FBG sensors to the trunk fiber, the analysis module is further configured to determine a passive fiber optic cabinet of the plurality of passive fiber optic cabinets that corresponds to the reflected light based on the determined wavelength of the reflected light and the time at which the reflected light is received.

40. The system according to claim 16, wherein an output wavelength range of the light source module is divided into a plurality of wavelength ranges to be assigned to the plurality of detection FBG sensors, a detection wavelength associated with each detection FBG sensor being within a wavelength range assigned to the detection FBG sensor, the analysis module is configured to determine, based on a wavelength range in which the determined wavelength of the reflected light is, a passive fiber optic cabinet of the plurality of passive fiber optic cabinets having a detection FBG sensor corresponding to the wavelength range.

41. The system according to claim 40, wherein the system further comprises an alarm module configured to issue an alarm in response to the analysis module determining that there is a wavelength range, among the plurality of wavelength ranges, that none of wavelengths of the received reflected lights falls therein.

42. A system for detecting a state of a door of a passive fiber optic cabinet, comprising:
a plurality of passive fiber optic cabinets, each being the passive fiber optic cabinet according to any of claims 1-11;
a light source module configured to provide light including detection wavelengths associated with the detection FBG sensors to the detection FBG sensors; and
an analysis module configured to
receive reflected lights reflected by the detection FBG sensors,
determine wavelengths of the reflected lights, and
determine whether the doors of the passive fiber optic cabinets are in an open state or a closed state based on the determined wavelengths of the reflected lights.

43. The system according to claim 42, wherein the detection FBG sensors of the plurality of passive fiber optic cabinets are disposed in a same optical fiber, and the detection wavelengths associated with the respective detection FBG sensors are different from each other.

44. The system according to claim 42, wherein the plurality of passive fiber optic cabinets comprises a first group of passive fiber optic cabinets and a second group of passive fiber optic cabinets, the detection FBG sensors of each of the first group of passive fiber optic cabinets are disposed in a first optical fiber, and the detection wavelengths associated with the respective detection FBG sensors of the first group of passive fiber optic cabinets are different from each other, the detection FBG sensors of each of the second group of passive fiber optic cabinets are disposed in a second optical fiber different from the first optical fiber, and the detection wavelengths associated with the respective detection FBG sensors of the second group of passive fiber optic cabinets are different from each other.

45. The system according to claim 44, wherein the detection wavelengths associated with the respective detection FBG sensors of the first group of passive fiber optic cabinets and the detection wavelengths associated with the respective detection FBG sensors of the second group of passive fiber optic cabinets have at least one same detection wavelength.

46. The system according to claim 45, wherein the light source module is configured to provide light to the respective detection FBG sensors of the first group of passive fiber optic cabinets and the respective detection FBG sensors of the second group of passive fiber optic cabinets via the first and second optical fibers, respectively, through an optical switch.

47. The system according to claim 45, wherein the detection FBG sensors of the first group of passive fiber optic cabinets include at least a first detection FBG sensor, the detection FBG sensors of the second group of passive fiber optic cabinets include at least a second detection FBG sensor, the first and second detection FBG sensors configured such that a detection wavelength associated with the first detection FBG sensor is the same as a detection wavelength associated with the second detection FBG sensor, and a distance along the fiber from the first detection FBG sensor to the analysis module and a distance along the fiber from the second detection FBG sensor to the analysis module differ by at least a first threshold configured such that a time difference between when the reflected lights from the first and second detection FBG sensors are received by the analysis module is no less than a predetermined time threshold.

48. The system according to claim 42, wherein the analysis module is configured to determine whether the doors of the passive fiber optic cabinets are in the open state or the closed state based on variations of the determined wavelengths of the reflected lights over time.
